(19) United States
(12) Patent Application Publication
(10) Pub. No.: US 2025/0039719 A1
(43) Pub. Date: Jan. 30, 2025

(54) ANTENNA CALIBRATION

(71) Applicant: Samsung Electronics Co., Ltd., Suwon-si (KR)

(72) Inventors: Md. Saifur Rahman, Plano, TX (US); Eko Onggosanusi, Coppell, TX (US); Gilwon Lee, McKinney, TX (US)

(21) Appl. No.: 18/769,225

(22) Filed: Jul. 10, 2024

Related U.S. Application Data
(60) Provisional application No. 63/527,447, filed on Jul. 18, 2023.
(60) Provisional application No. 63/536,648, filed on Sep. 5, 2023.

(51) Int. Cl. H04W 24/10; H04L 5/00

(52) U.S. Cl. CPC H04W 24/10; H04L 5/0057

(57) ABSTRACT

Apparatuses and methods for antenna calibration. A method performed by a user equipment (UE) includes receiving a configuration about a calibration report, the configuration including information about (i) K groups of channel state information reference signal (CSI-RS) ports, where K>1, and (ii) a type of the calibration report; based on the configuration, determining a calibration offset for each of the K groups of CSI-RS ports; and transmitting the calibration report including at least one indicator indicating the calibration offset for each of the K groups of CSI-RS ports. The type of the calibration report (i) is based on the calibration offset and (ii) corresponds to at least one of a delay offset (DO), a frequency offset (FO), and a phase offset (PO). The calibration report relates to a coherent joint transmission (CJT) across the K groups of CSI-RS ports.

### CROSS-REFERENCE TO RELATED APPLICATION AND CLAIM OF PRIORITY

This application claims priority under 35 U.S.C. § 119(e) to U.S. Provisional Patent Application No. 63/527,447 filed on Jul. 18, 2023, and U.S. Provisional Patent Application No. 63/536,648 filed on Sep. 5, 2023, which provisional patent applications are hereby incorporated by reference in their entirety.

### TECHNICAL FIELD

The present disclosure relates generally to wireless communication systems and, more specifically, to antenna calibration.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to apparatuses and methods for antenna calibration.

In one embodiment, a user equipment (UE) is provided. The UE includes a transceiver configured to receive a configuration about a calibration report. The configuration includes information about (i) K groups of channel state information reference signal (CSI-RS) ports, where K>1, and (ii) a type of the calibration report. The UE further includes a processor operably coupled to the transceiver. The processor, based on the configuration, is configured to determine a calibration offset for each of the K groups of CSI-RS ports. The transceiver is further configured to transmit the calibration report including at least one indicator indicating the calibration offset for each of the K groups of CSI-RS ports. The type of the calibration report (i) is based on the calibration offset and (ii) corresponds to at least one of a delay offset (DO), a frequency offset (FO), and a phase offset (PO). The calibration report relates to a coherent joint transmission (CJT) across the K groups of CSI-RS ports.

In another embodiment, a base station (BS) is provided. The BS includes a processor and a transceiver operably coupled to the processor. The transceiver is configured to transmit a configuration about a calibration report, the configuration including information about (i) K groups of CSI-RS ports, where K>1, and (ii) a type of the calibration report; and receive the calibration report including at least one indicator indicating a calibration offset for each of the K groups of CSI-RS ports. The type of the calibration report (i) is based on the calibration offset and (ii) corresponds to at least one of a DO, a FO, and a PO. The calibration report relates to a CJT across the K groups of CSI-RS ports.

In yet another embodiment, a method performed by a UE is provided. The method includes receiving a configuration about a calibration report, the configuration including information about (i) K groups of CSI-RS ports, where K>1, and (ii) a type of the calibration report; based on the configuration, determining a calibration offset for each of the K groups of CSI-RS ports; and transmitting the calibration report including at least one indicator indicating the calibration offset for each of the K groups of CSI-RS ports. The type of the calibration report (i) is based on the calibration offset and (ii) corresponds to at least one of a DO, a FO, and a PO. The calibration report relates to a CJT across the K groups of CSI-RS ports.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4 and 5 illustrate example wireless transmit and receive paths according to embodiments of the present disclosure;

FIG. 6 illustrates a transmitter block diagram for a physical downlink shared channel (PDSCH) in a subframe according to embodiments of the present disclosure;

FIG. 7 illustrates a receiver block diagram for a PDSCH in a subframe according to embodiments of the present disclosure;

FIG. 8 illustrates a transmitter block diagram for a physical uplink shared channel (PUSCH) in a subframe according to embodiments of the present disclosure;

FIG. 9 illustrates a receiver block diagram for a PUSCH in a subframe according to embodiments of the present disclosure;

FIG. 10 illustrates an example antenna blocks or arrays forming beams according to embodiments of the present disclosure;

FIG. 11 illustrates an example antenna port layout and antenna group TRP according to embodiments of the present disclosure;

FIG. 12 illustrates co-located and distributed antenna groups (AGs) serving a moving UE according to embodiments of the present disclosure;

FIG. 13 illustrates an example of a UE configured with a CRI-based reporting scheme according to embodiments of the present disclosure;

FIG. 14 illustrates an example of a UE configured with a CB-based reporting scheme according to embodiments of the present disclosure;

FIG. 15 illustrates an example of a UE configured with a CRI+CB-based reporting scheme according to embodiments of the present disclosure; and

FIG. 16 illustrates an example method performed by a UE in a wireless communication system according to embodiments of the present disclosure.

### DETAILED DESCRIPTION

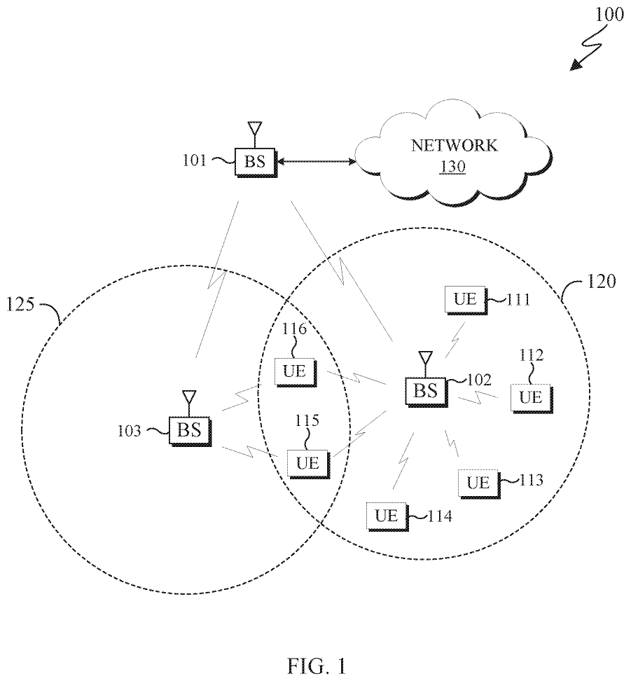

FIGS. 1 through 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein: 3GPP TS 36.211 v17.3.0, “E-UTRA, Physical channels and modulation (herein “REF 1”);” 3GPP TS 36.212 v17.1.0, “E-UTRA, Multiplexing and Channel coding” (herein “REF 2”); 3GPP TS 36.213 v17.3.0, “E-UTRA, Physical Layer Procedures” (herein “REF 3”); 3GPP TS 36.321 v17.3.0, “E-UTRA, Medium Access Control (MAC) protocol specification” (herein “REF 4”); 3GPP TS 36.331 v17.3.0, “E-UTRA, Radio Resource Control (RRC) Protocol Specification” (herein “REF 5”); 3GPP TR 22.891 v1.2.0 (herein “REF 6”); 3GPP TS 38.212 v17.3.0, “E-UTRA, NR, Multiplexing and Channel coding” (herein “REF 7”); 3GPP TS 38.214 v17.3.0, “E-UTRA, NR, Physical layer procedures for data” (herein “REF 8”); 3GPP TS 38.211 v17.3.0, “E-UTRA, NR, Physical channels and modulation” (herein “REF 9”).

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

In the 5G/NR system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for facilitating antenna calibration. In certain embodiments, one or more of the BSs 101-103 include circuitry, programing, or a combination thereof for facilitating antenna calibration.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

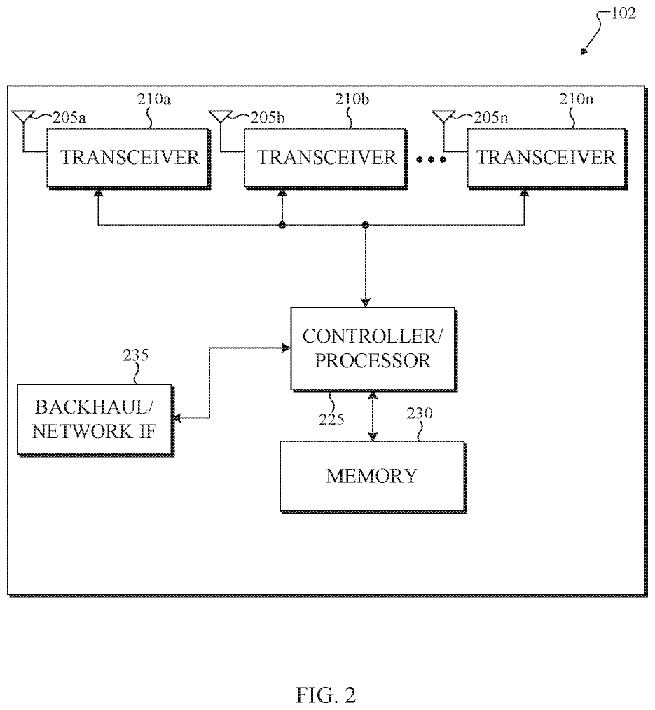

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for facilitating antenna calibration. Any of a wide variety of other functions could be supported in the gNB 102 by the controller/processor 225.

The controller/processor 225 is also capable of executing programs and other processes resident in the memory 230, such as processes for facilitating antenna calibration. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

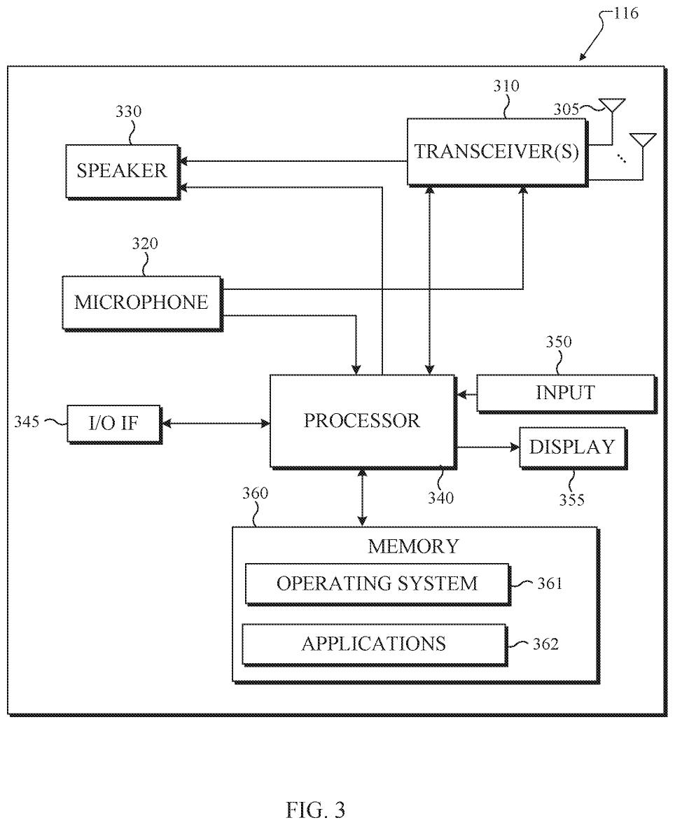

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for facilitating antenna calibration. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

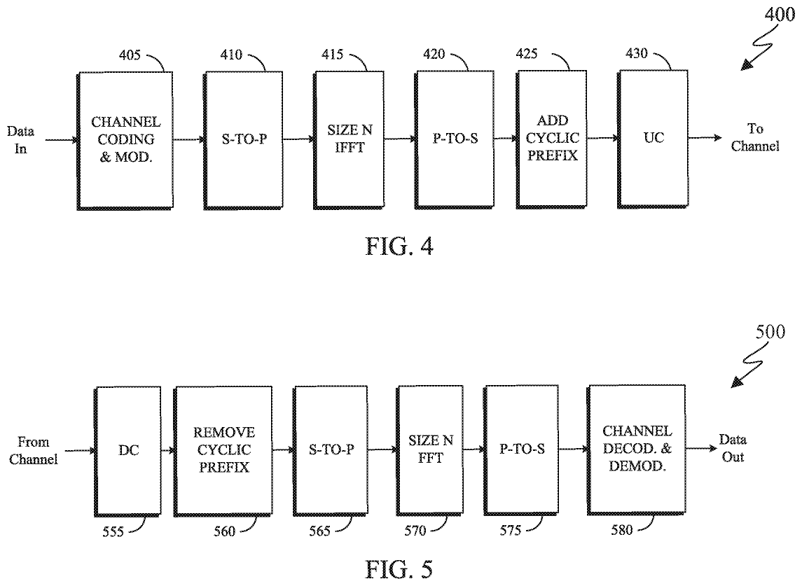

FIG. 4 and FIG. 5 illustrate example wireless transmit and receive paths according to this disclosure. In the following description, a transmit path 400, of FIG. 4, may be described as being implemented in a BS (such as the BS 102), while a receive path 500, of FIG. 5, may be described as being implemented in a UE (such as a UE 116). However, it may be understood that the receive path 500 can be implemented in a BS and that the transmit path 400 can be implemented in a UE. In some embodiments, the receive path 500 is configured to facilitate antenna calibration as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the BSs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the BSs 101-103 and may implement the receive path 500 for receiving in the downlink from the BSs 101-103.

Each of the components in FIG. 4 and FIG. 5 can be implemented using hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A communication system includes a downlink (DL) that conveys signals from transmission points such as base stations (BSs) or NodeBs to user equipments (UEs) and an Uplink (UL) that conveys signals from UEs to reception points such as NodeBs. A UE, also commonly referred to as a terminal or a mobile station, may be fixed or mobile and may be a cellular phone, a personal computer device, or an automated device. An eNodeB, which is generally a fixed station, may also be referred to as an access point or other equivalent terminology. For LTE systems, a NodeB is often referred as an eNodeB.

In a communication system, such as LTE, DL signals can include data signals conveying information content, control signals conveying DL control information (DCI), and reference signals (RS) that are also known as pilot signals. An eNodeB transmits data information through a physical DL shared channel (PDSCH). An eNodeB transmits DCI through a physical DL control channel (PDCCH) or an Enhanced PDCCH (EPDCCH)—see also REF 3. An eNodeB transmits acknowledgement information in response to data transport block (TB) transmission from a UE in a physical hybrid ARQ indicator channel (PHICH). An eNodeB transmits one or more of multiple types of RS including a UE-common RS (CRS), a channel state information RS (CSI-RS), or a demodulation RS (DMRS). A CRS is transmitted over a DL system bandwidth (BW) and can be used by UEs to obtain a channel estimate to demodulate data or control information or to perform measurements. To reduce CRS overhead, an eNodeB may transmit a CSI-RS with a smaller density in the time and/or frequency domain than a CRS. DMRS can be transmitted only in the BW of a respective PDSCH or EPDCCH and a UE can use the DMRS to demodulate data or control information in a PDSCH or an EPDCCH, respectively. A transmission time interval for DL channels is referred to as a subframe and can have, for example, duration of 1 millisecond.

DL signals also include transmission of a logical channel that carries system control information. A BCCH is mapped to either a transport channel referred to as a broadcast channel (BCH) when the DL signals convey a master information block (MIB) or to a DL shared channel (DL-SCH) when the DL signals convey a System Information Block (SIB). Most system information is included in different SIBs that are transmitted using DL-SCH. A presence of system information on a DL-SCH in a subframe can be indicated by a transmission of a corresponding PDCCH conveying a codeword with a cyclic redundancy check (CRC) scrambled with system information RNTI (SI-RNTI). Alternatively, scheduling information for a SIB transmission can be provided in an earlier SIB and scheduling information for the first SIB (SIB-1) can be provided by the MIB.

DL resource allocation is performed in a unit of subframe and a group of physical resource blocks (PRBs). A transmission BW includes frequency resource units referred to as resource blocks (RBs). Each RB includes N_{sc}^{RB} sub-carriers, or Resource Elements (REs), such as 12 REs. A unit of one RB over one subframe (or slot) is referred to as a PRB. A UE can be allocated M_{PDSCH} RBs for a total of M_{sc}^{PDSCH}=M_{PDSCH}·N_{sc}^{RB} REs for the PDSCH transmission BW.

UL signals can include data signals conveying data information, control signals conveying UL control information (UCI), and UL RS. UL RS includes DMRS and Sounding RS (SRS). A UE transmits DMRS only in a BW of a respective PUSCH or PUCCH. An eNodeB can use a DMRS to demodulate data signals or UCI signals. A UE transmits SRS to provide an eNodeB with an UL CSI. A UE transmits data information or UCI through a respective physical UL shared channel (PUSCH) or a Physical UL control channel (PUCCH). If a UE needs to transmit data information and UCI in a same UL subframe, the UE may multiplex both in a PUSCH. UCI includes Hybrid Automatic Repeat request acknowledgement (HARQ-ACK) information, indicating correct (ACK) or incorrect (NACK) detection for a data TB in a PDSCH or absence of a PDCCH detection (DTX), scheduling request (SR) indicating whether a UE has data in the UE's buffer, rank indicator (RI), and channel state information (CSI) enabling an eNodeB to perform link adaptation for PDSCH transmissions to a UE. HARQ-ACK information is also transmitted by a UE in response to a detection of a PDCCH/EPDCCH indicating a release of semi-persistently scheduled PDSCH (see also REF 3).

A UL subframe (or slot) includes two slots. Each slot includes NU b symbols for transmitting data information, UCI, DMRS, or SRS. A frequency resource unit of an UL system BW is an RB. A UE is allocated N_{RB} RBs for a total of N_{RB}·N_{sc}^{RB} REs for a transmission BW. For a PUCCH, N_{RB}=1. A last subframe (or slot) symbol can be used to multiplex SRS transmissions from one or more UEs. A number of subframe (or slot) symbols that are available for data/UCI/DMRS transmission is N_{symb}=2·(N_{symb}^{UL}−1)−N_{SRS}, where N_{SRS}=1 if a last subframe (or slot) symbol is used to transmit SRS and N_{SRS}=0 otherwise.

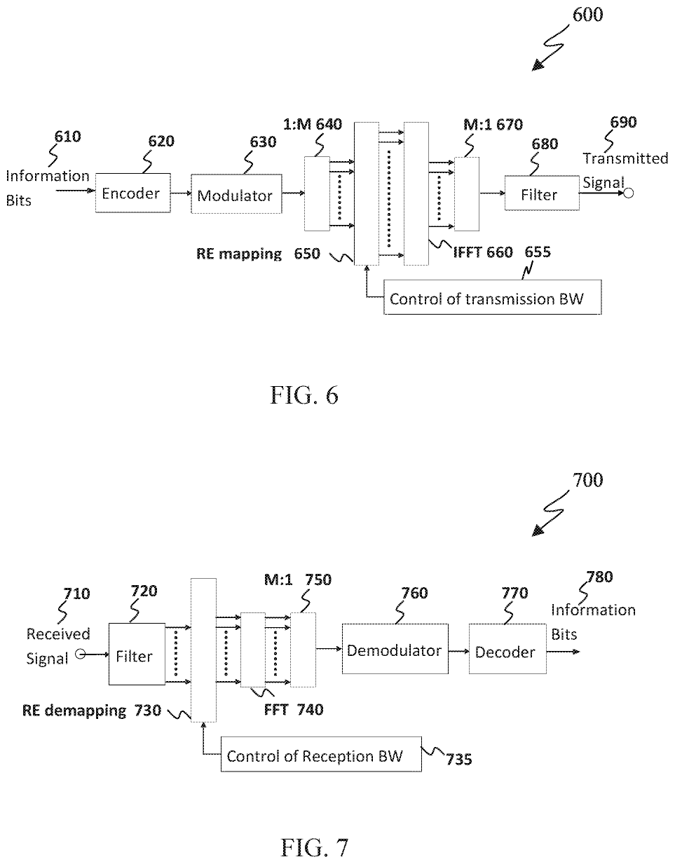

FIG. 6 illustrates a transmitter block diagram 600 for a PDSCH in a subframe according to embodiments of the present disclosure. The embodiment of the transmitter block diagram 600 illustrated in FIG. 6 is for illustration only. One or more of the components illustrated in FIG. 6 can be implemented in specialized circuitry configured to perform the noted functions or one or more of the components can be implemented by one or more processors executing instructions to perform the noted functions. FIG. 6 does not limit the scope of this disclosure to any particular implementation of the transmitter block diagram 600.

As shown in FIG. 6, information bits 610 are encoded by encoder 620, such as a turbo encoder, and modulated by modulator 630, for example using quadrature phase shift keying (QPSK) modulation. A serial to parallel (S/P) converter 640 generates M modulation symbols that are subsequently provided to a mapper 650 to be mapped to REs selected by a transmission BW selection unit 655 for an assigned PDSCH transmission BW, unit 660 applies an Inverse fast Fourier transform (IFFT), the output is then serialized by a parallel to serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

FIG. 7 illustrates a receiver block diagram 700 for a PDSCH in a subframe according to embodiments of the present disclosure. The embodiment of the diagram 700 illustrated in FIG. 7 is for illustration only. One or more of the components illustrated in FIG. 7 can be implemented in specialized circuitry configured to perform the noted functions or one or more of the components can be implemented by one or more processors executing instructions to perform the noted functions. FIG. 7 does not limit the scope of this disclosure to any particular implementation of the diagram 700.

As shown in FIG. 7, a received signal 710 is filtered by filter 720, REs 730 for an assigned reception BW are selected by BW selector 735, unit 740 applies a fast Fourier transform (FFT), and an output is serialized by a parallel-to-serial converter 750. Subsequently, a demodulator 760 coherently demodulates data symbols by applying a channel estimate obtained from a DMRS or a CRS (not shown), and a decoder 770, such as a turbo decoder, decodes the demodulated data to provide an estimate of the information data bits 780. Additional functionalities such as time-windowing, cyclic prefix removal, de-scrambling, channel estimation, and de-interleaving are not shown for brevity.

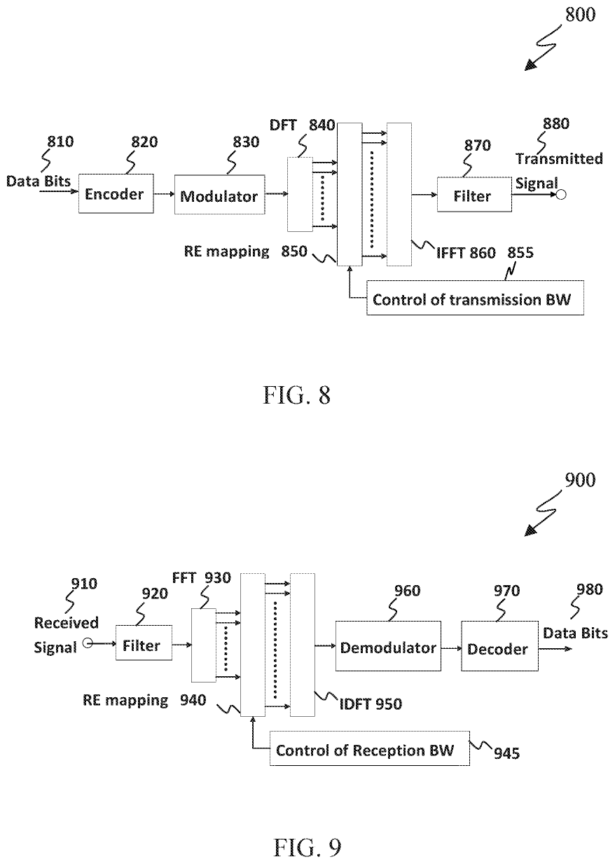

FIG. 8 illustrates a transmitter block diagram 800 for a PUSCH in a subframe according to embodiments of the present disclosure. One or more of the components illustrated in FIG. 7 can be implemented in specialized circuitry configured to perform the noted functions or one or more of the components can be implemented by one or more processors executing instructions to perform the noted functions. The embodiment of the block diagram 800 illustrated in FIG. 8 is for illustration only. FIG. 8 does not limit the scope of this disclosure to any particular implementation of the block diagram 800.

As shown in FIG. 8, information data bits 810 are encoded by encoder 820, such as a turbo encoder, and modulated by modulator 830. A discrete Fourier transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

FIG. 9 illustrates a receiver block diagram 900 for a PUSCH in a subframe according to embodiments of the present disclosure. The embodiment of the block diagram 900 illustrated in FIG. 9 is for illustration only. One or more of the components illustrated in FIG. 9 can be implemented in specialized circuitry configured to perform the noted functions or one or more of the components can be implemented by one or more processors executing instructions to perform the noted functions. FIG. 9 does not limit the scope of this disclosure to any particular implementation of the block diagram 900.

As shown in FIG. 9, a received signal 910 is filtered by filter 920. Subsequently, after a cyclic prefix is removed (not shown), unit 930 applies an FFT, REs 940 corresponding to an assigned PUSCH reception BW are selected by a reception BW selector 945, unit 950 applies an inverse DFT (IDFT), a demodulator 960 coherently demodulates data symbols by applying a channel estimate obtained from a DMRS (not shown), a decoder 970, such as a turbo decoder, decodes the demodulated data to provide an estimate of the information data bits 980.

There are two types of frequency range (FR) defined in 3GPP 5G NR specifications. The sub-6 GHz range is called frequency range 1 (FR1) and millimeter wave range is called frequency range 2 (FR2). An example of the frequency range for FR1 and FR2 is shown below.

| Frequency range designation | Corresponding frequency range |
|---|---|
| FR1 | 450 MHz-6000 MHz |
| FR2 | 24250 MHz-52600 MHz |

For MIMO in FR1, up to 32 CSI-RS antenna ports in one CSI-RS resource is supported, and in FR2, up to 8 CSI-RS antenna ports in one CSI-RS resource is supported. A (spatial or digital) precoding/beamforming can be used across these large number of antenna ports in order to achieve MIMO gains. Depending on the carrier frequency, and the feasibility of RF/HW-related components, the (spatial) precoding/beamforming can be fully digital or hybrid analog-digital.

In fully digital beamforming, there can be one-to-one mapping between an antenna port and an antenna element, or a ‘static/fixed’ virtualization of multiple antenna elements to one antenna port can be used. Each antenna port can be digitally controlled. Hence, a spatial multiplexing across all antenna ports is possible.

In a hybrid analog-digital beamforming, analog beamforming corresponds to a ‘dynamic/varying’ virtualization of multiple antenna elements to obtain one antenna port (or antenna panel). Although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies).

For MIMO in FR1, up to 32 CSI-RS antenna ports is supported, and in FR2, up to 8 CSI-RS antenna ports is supported. In next generation cellular standards (e.g., 6G), in addition to FR1 and FR2, new carrier frequency bands can be considered, e.g., FR4 (>52.6 GHz), terahertz (>100 GHz) and upper mid-band (10-15 GHz). The number of CSI-RS ports that can be supported for these new bands is likely to be different from FR1 and FR2. In particular, for 10-15 GHz band, the max number of CSI-RS antenna ports is likely to be more than FR1, due to smaller antenna form factors, and feasibility of fully digital beamforming (as in FR1) at these frequencies. For instance, the number of CSI-RS antenna ports can grow up to 128. Besides, the NW deployment/topology at these frequencies is also expected to be denser/distributed, for example, antenna ports distributed at multiple (potentially non-co-located, hence geographically separated) TRPs within a cellular region can be the main scenario of interest, due to which the number of CSI-RS antenna ports for MIMO can be even larger (e.g., up to 256).

Likewise, for a cellular system operating in low carrier frequency in general, a sub-1 GHz frequency range (e.g., less than 1 GHz) as an example, supporting large number of CSI-RS antenna ports (e.g., 32) or many antenna elements at a single location or remote radio head (RRH) or TRP is challenging due to a larger antenna form factor size needed considering carrier frequency wavelength than a system operating at a higher frequency such as 2 GHz or 4 GHz. At such low frequencies, the maximum number of CSI-RS antenna ports that can be co-located at a site (or RRH or TRP) can be limited, for example to 8. This limits the spectral efficiency of such systems. In particular, the MU-MIMO spatial multiplexing gains offered due to large number of CSI-RS antenna ports (such as 32) can't be achieved due to the antenna form factor limitation. One plausible way to operate a system with large number of CSI-RS antenna ports at low carrier frequency is to distribute the physical antenna ports to different panels/RRHs/TRPs, which can be possibly non-collocated. The multiple sites or panels/RRHs/TRPs can still be connected to a single (common) base unit forming a single antenna system, hence the signal transmitted/received via multiple distributed RRHs/TRPs can still be processed at a centralized location.

As described above, for low (FR1), high (FR2 and beyond), or mid (6-15 GHz) band, the NW topology/architecture is likely to be more and more distributed in future due to reasons explained above (e.g., use cases, HW requirements, antenna form factors, mobility etc.). In this disclosure, such a distributed system is referred to as a DMIMO or multiple TRP (mTRP) system (multiple antenna port groups, which can be non-co-located). The transmission in such a system can be coherent joint transmission (CJT), i.e., a layer can be transmitted across/using multiple TRPs, or non-coherent joint transmission (NCJT). Due to distributed nature of operation, the groups of antenna ports (or TRPs) need to be calibrated/synchronized by compensating for the non-idealities such as time/frequency/phase offsets non-ideal backhaul across TRPs, due to HW impairments, different delay profiles, and Doppler profile (in high-speed scenarios) associated with different TRPs.

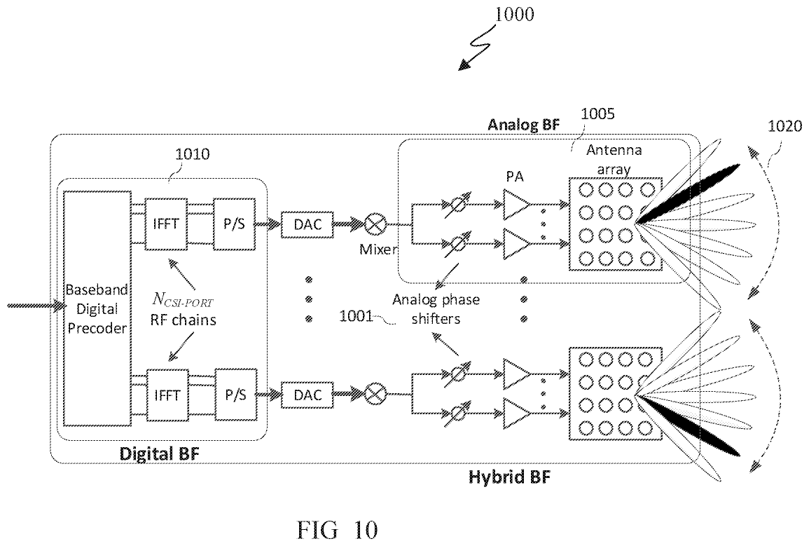

FIG. 10 illustrates an example antenna blocks or arrays 1000 according to embodiments of the present disclosure. The embodiment of the antenna blocks or arrays 1000 illustrated in FIG. 10 is for illustration only. FIG. 10 does not limit the scope of this disclosure to any particular implementation of the antenna blocks or arrays.

In a hybrid analog-digital beamforming, analog beamforming corresponds to a ‘dynamic/varying’ virtualization of multiple antenna elements to obtain one antenna port (or antenna panel). Although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 10. In this case, one CSI-RS port is mapped onto a large number of antenna elements which can be controlled by a bank of analog phase shifters 1001. One CSI-RS port can then correspond to one sub-array which produces a narrow analog beam through analog beamforming 1005. This analog beam can be configured to sweep across a wider range of angles 1020 by varying the phase shifter bank across symbols or subframes (or slots). The number of sub-arrays (equal to the number of RF chains) is the same as the number of antenna ports N_{PORT}. A digital beamforming unit 1010 performs a linear combination across N_{PORT} analog beams to further increase precoding gain. While analog beams are wideband (hence not frequency-selective), digital precoding can be varied across frequency sub-bands or resource blocks. Receiver operation can be conceived analogously.

Since the above system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The above system is also applicable to higher frequency bands such as >52.6 GHz (also termed the FR4). In this case, the system can employ only analog beams. Due to the O2 absorption loss around 60 GHz frequency (˜10 dB additional loss @ 100 m distance), larger number of and sharper analog beams (hence larger number of radiators in the array) will be needed to compensate for the additional path loss.

In next generation cellular standards (e.g., 6G), in addition to FR1 and FR2, new carrier frequency bands can be considered, e.g., FR4 (>52.6 GHz), terahertz (>100 GHz) and upper mid-band (10-15 GHz). The number of CSI-RS ports that can be supported for these new bands is likely to be different from FR1 and FR2. In particular, for 10-15 GHz band, the max number of CSI-RS antenna ports is likely to be more than FR1, due to smaller antenna form factors, and feasibility of fully digital beamforming (as in FR1) at these frequencies. For instance, the number of CSI-RS antenna ports can grow up to 128. Besides, the NW deployment/topology at these frequencies is also expected to be denser/distributed, for example, antenna ports distributed at multiple (potentially non-co-located, hence geographically separated) TRPs within a cellular region can be the main scenario of interest, due to which the number of CSI-RS antenna ports for MIMO can be even larger (e.g., up to 256).

Likewise, for a cellular system operating in low carrier frequency in general, a sub-1 GHz frequency range (e.g., less than 1 GHz) as an example, supporting large number of CSI-RS antenna ports (e.g., 32) or many antenna elements at a single location or remote radio head (RRH) or TRP is challenging due to a larger antenna form factor size needed considering carrier frequency wavelength than a system operating at a higher frequency such as 2 GHz or 4 GHz. At such low frequencies, the maximum number of CSI-RS antenna ports that can be co-located at a site (or RRH or TRP) can be limited, for example to 8. This limits the spectral efficiency of such systems. In particular, the MU-MIMO spatial multiplexing gains offered due to large number of CSI-RS antenna ports (such as 32) can't be achieved due to the antenna form factor limitation. One plausible way to operate a system with large number of CSI-RS antenna ports at low carrier frequency is to distribute the physical antenna ports to different panels/RRHs/TRPs, which can be possibly non-collocated. The multiple sites or panels/RRHs/TRPs can still be connected to a single (common) base unit forming a single antenna system, hence the signal transmitted/received via multiple distributed RRHs/TRPs can still be processed at a centralized location.

As described above, for low (FR1), high (FR2 and beyond), or mid (6-15 GHz) band, the NW topology/architecture is likely to be more and more distributed in future due to reasons explained above (e.g., use cases, HW requirements, antenna form factors, mobility etc.). In this disclosure, such a distributed system is referred to as a DMIMO or multiple TRP (mTRP) system (multiple antenna port groups, which can be non-co-located). The transmission in such a system can be coherent joint transmission (CJT), i.e., a layer can be transmitted across/using multiple TRPs, or non-coherent joint transmission (NCJT). Due to distributed nature of operation, the groups of antenna ports (or TRPs) need to be calibrated/synchronized by compensating for the non-idealities such as time/frequency/phase offsets non-ideal backhaul across TRPs, due to HW impairments, different delay profiles, and Doppler profile (in high-speed scenarios) associated with different TRPs.

Embodiments of the present disclosure recognize that in a wireless communication system, MIMO is often identified as an essential feature in order to achieve high system throughput requirements. One of the key components of a MIMO transmission scheme is the accurate CSI acquisition at the eNB (or gNB) (or TRP). For MU-MIMO, in particular, the availability of accurate CSI is necessary in order to guarantee high MU performance. For time division duplexing (TDD) systems, the CSI can be acquired using the SRS transmission relying on the channel reciprocity. For frequency division duplexing (FDD systems), on the other hand, it can be acquired using the CSI-RS transmission from eNB (or gNB), and CSI acquisition and feedback from UE.

In 5G or NR systems [REF7, REF8], both low- (aka Type I) and high-resolution (aka Type II) CSI reporting mechanisms are supported. In addition, to reduce Type II CSI reporting, a frequency domain (FD) compression based Type II CSI is also supported, which is based on (a) spatial domain (SD) basis W₁, (b) FD basis W_{f}, and (c) coefficients W₂ that linearly combine SD and FD bases. For a (full TDD or partial FDD) reciprocity, CSI-RS ports can be beamformed (using SRS measurements, assuming UL-DL channel reciprocity in angular/delay), and the SD basis corresponds to a port selection basis.

In Rel. 18, the FD-compression-based Type II CSI is further enhanced for the use case of CJT across up to 4 TRPs, under the idealistic assumptions such as perfectly time and frequency synchronized mTRPs, phase-coherent antenna ports and ideal backhaul links. In practice, however, these assumptions are not valid, and calibration/synchronization across TRPs is necessary in order to make CJT feasible.

Massive MIMO base stations or TRPs use an on-board coupling network and calibration circuits, referred to as the on-board calibration for brevity, to measure the gain and phase differences among transceivers in the same radio frequency (RF) unit in order to maintain the reciprocity between DL and UL channels, in the TDD system in particular. For the on-board calibration, one RF chain corresponding to one antenna port serves as a reference to other RF chains for other antenna ports. In the case of the mTRP system, such reference transceiver's signal needs to be shared between distributed RRHs/panels/modules/TRPs, which are physically far apart or non-co-located. Using RF cables to distribute the reference is not preferable as it limits the deployment scenarios. In addition, the use of different local oscillators (LOs) between distributed antenna modules imposes even more challenges in achieving calibration as the phase of LOs could drift. Periodic calibration is needed to compensate for the phase drift as well.

Embodiments of the present disclosure recognize that the timing offset can be expressed as Tₜ=e^{j2πf(t+Δt)}, where Δt is due to timing difference between (distributed, non-co-located) TRPs and/or different propagation delays from different TRPs, which amounts to increased frequency-selectivity of the composite channel. The minimum frequency granularity (supported in NR) is 2 RBs (for PMI) and 4 RBs (CQI), which correspond to a max delay spread 2.8 and 1.4 microsecond for SCS=15 and 30 kHz, respectively. This delay spread decreases further with increasing frequency granularity (due to timing offset). For large delay spread, the required frequency granularity for CJT (across TRPs) will be smaller than 2RBs.

TABLE 9.6.1.3-1
OTA frequency error minimum requirement

| BS Class | Accuracy | |
|---|---|---|
| Wide Area BS | ±0.05 | ppm |
| Medium Range BS | ±0.1 | ppm |
| Local Area BS | ±0.1 | ppm |

Embodiments of the present disclosure recognize that the frequency offset can be expressed as T_{f}=e^{j2π(f+Δf)t}, where Δf is due to non-ideal (and potentially different) local oscillators or crystal types at different TRPs, which results in frequency differences between TRPs. As shown above, the minimum frequency error=0.05 ppm, according to TS 38.104. The phase change due to frequency error can be significant, especially at higher carrier frequencies.

In general, the combined (time-frequency) T-F offset can be expressed as T_{t,f}=e^{j2π(f+Δf)(t+Δt)}. For CJT feasibility, (Δt, Δf) needs to be calibrated for frequently.

Embodiments of the present disclosure recognize that non-ideal backhaul links between TRPs, especially when the backhaul links are not fiber-optic cables.

Embodiments of the present disclosure recognize that phase-coherency across antenna ports, both intra-TRP (within each TRP) and inter-TRP (across TRPs).

Embodiments of the present disclosure recognize that a TRP or RRH can be functionally equivalent to (hence can be replaced with) or is interchangeable with one of more of the following: an antenna, or an antenna group (multiple antennae), an antenna port, an antenna port group (multiple ports), a CSI-RS resource, multiple CSI-RS resources, a CSI-RS resource set, multiple CSI-RS resource sets, an antenna panel, multiple antenna panels, a Tx-Rx entity, a (analog) beam, a (analog) beam group, a cell, a cell group.

Embodiments of the present disclosure propose over-the-air (OTA) signaling mechanisms for calibration among multiple TRPs or RRHs. The mechanisms comprise 1) DL RS (e.g., CSI-RS) transmission from mTRPs and measurement (by the UE) and 2) reporting related to the calibration information (e.g., amp/phase of calibration coefficients).

Embodiments of the present disclosure propose three reporting schemes (CRI-based, CB-based, and CRI+CB-based). Further, embodiments of the present disclosure propose DL-RS for the three schemes. In addition, embodiments of the present disclosure propose quantization of calibration coefficients.

Although the focus of this disclosure is on 3GPP 5G NR communication systems, various embodiments may apply in general to UEs operating with other RATs and/or standards, such as different releases/generations of 3GPP standards (including beyond 5G, 6G, and so on), IEEE standards (such as 802.16 WiMAX and 802.11 Wi-Fi), and so on.

Aspects, features, and advantages of the present disclosure are readily apparent from the following detailed description, simply by illustrating a number of particular embodiments and implementations, including the best mode contemplated for carrying out the disclosure. The present disclosure is also capable of other and different embodiments, and its several details can be modified in various obvious respects, all without departing from the spirit and scope of the present disclosure. Accordingly, the drawings and description are to be regarded as illustrative in nature, and not as restrictive. The present disclosure is illustrated by way of example, and not by way of limitation, in the figures of the accompanying drawings.

In the following, for brevity, both FDD and TDD are considered as the duplex method for both DL and UL signaling.

Although exemplary descriptions and embodiments to follow assume orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This present disclosure covers several components which can be used in conjunction or in combination with one another, or can operate as standalone schemes.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, all the following components and embodiments are applicable for UL transmission when the scheduling unit in time is either one subframe (which can consist of one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include all the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” can also be used.

In terms of UE configuration, a UE can be configured with at least one CSI reporting band. This configuration can be semi-static (via higher-layer signaling or RRC) or dynamic (via MAC CE or L1 DL control signaling). When configured with multiple (N) CSI reporting bands (e.g., via RRC signaling), a UE can report CSI associated with n≤N CSI reporting bands. For instance, >6 GHz, large system bandwidth may require multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for all the Mn subbands within the CSI reporting band. A CSI parameter is configured with “subband” for the CSI reporting band with Mn subbands when one CSI parameter is reported for each of the Mn subbands within the CSI reporting band.

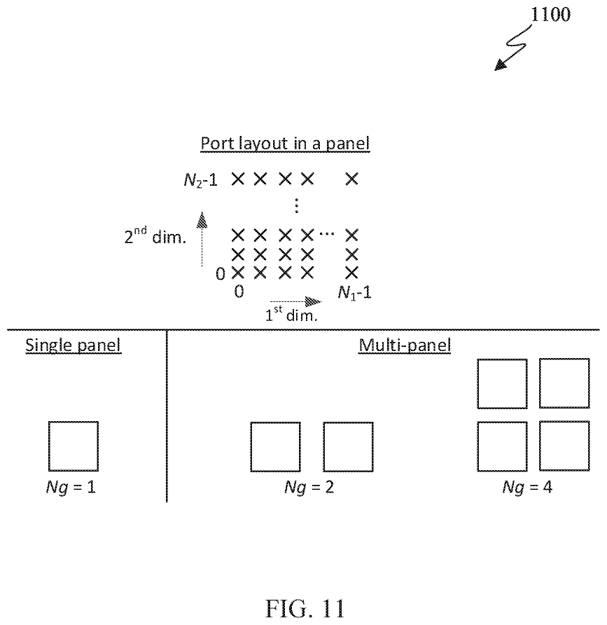

FIG. 11 illustrates an example antenna port layout and antenna group TRP 1100 according to embodiments of the present disclosure. The embodiment of the antenna port layout and antenna group TRP 1100 illustrated in FIG. 11 is for illustration only. FIG. 11 does not limit the scope of this disclosure to any particular implementation of the antenna port layout and antenna group TRP.

As illustrated in FIG. 11, N₁ and N₂ are the number of antenna ports with the same polarization in the first and second dimensions, respectively. For 2D antenna port layouts, we have N₁>1, N₂>1, and for 1D antenna port layouts N₁>1 and N₂=1 (or N₁=1 and N₂>1). For a single-polarized (or co-polarized) antenna port layout, the total number of antenna ports is P_{CSIRS}=N₁N₂. And, for a dual-polarized antenna port layout, the total number of antenna ports is P_{CSIRS}=2N₁N₂. An illustration is shown in FIG. 11 where “X” represents two antenna polarizations. In this disclosure, the term “polarization” refers to a group of antenna ports with the same polarization. For example, antenna ports

$$\\ j = X + 0 , X + 1 , … , X + \frac{{P}_{CSIRS}}{2} - 1$$

comprise a first antenna polarization, and antenna ports

$$\\ j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-RS antenna ports and X is a starting antenna port number (e.g., X=3000, then antenna ports are 3000, 3001, 3002, . . . ). Dual-polarized antenna payouts are assumed in this disclosure. The embodiments (and examples) in this disclosure however are general and are applicable to single-polarized antenna layouts as well.

Let N_{g} be a number of antenna groups (AGs). When there are multiple antenna groups (N_{g}>1), we assume that each group (g∈{1, . . . , N_{g}}) comprises dual-polarized antenna ports with N_{1,g} and N_{2,g} ports in two dimensions. This is illustrated in FIG. 11. Note that the antenna port layouts may be the same (N_{1,g}=N₁ and N_{2,g}=N₂) in different antenna groups, or they can be different across antenna groups. For group g, the number of antenna ports is P_{CSIRS,g}=N_{1,g}N_{2,g} or 2N_{1,g}N_{2,g}(for co-polarized or dual-polarized respectively).

In one example, an antenna group corresponds to an antenna panel. In one example, an antenna group corresponds to a TRP. In one example, an antenna group corresponds to an RRH. In one example, an antenna group corresponds to CSI-RS antenna ports of a NZP CSI-RS resource. In one example, an antenna group corresponds to a subset of CSI-RS antenna ports of a NZP CSI-RS resource (comprising multiple antenna groups). In one example, an antenna group corresponds to CSI-RS antenna ports of multiple NZP CSI-RS resources (e.g., comprising a CSI-RS resource set).

In one example, an antenna group corresponds to a reconfigurable intelligent surface (RIS) in which the antenna group can be (re-)configured more dynamically (e.g., via MAC CE and/or DCI). For example, the number of antenna ports associated with the antenna group can be changed dynamically.

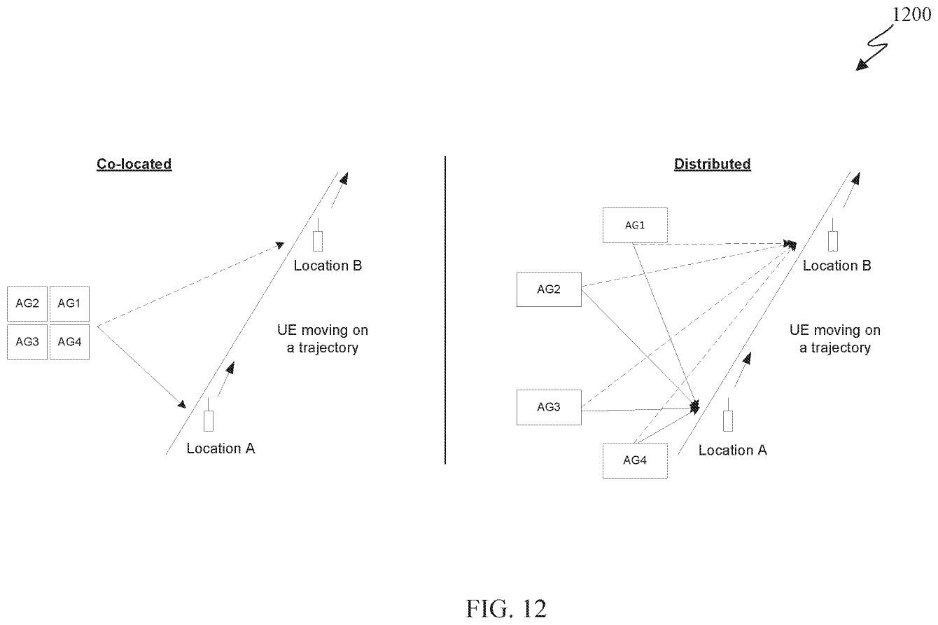

FIG. 12 illustrates co-located and distributed antenna groups (AGs) serving a moving UE 1200 according to embodiments of the present disclosure. The embodiment of the co-located and distributed antenna groups (AGs) serving a moving UE 1200 illustrated in FIG. 12 is for illustration only. FIG. 12 does not limit the scope of this disclosure to any particular implementation of the co-located and distributed antenna groups (AGs) serving a moving UE 1200.

In one example scenario, multiple AGs can be co-located or distributed, and can serve static (non-mobile) or moving UEs. An illustration of AGs serving a moving UE is shown in FIG. 12. While the UE moves from a location A to another location B, the UE measures the channel, e.g., via NZP CSI-RS resources, (may also measure the interference, e.g., via CSI-IM resources or CSI-RS resources for interference measurement), uses the measurement to determine/report CSI considering joint transmission from multiple AGs. The reported CSI can be based on a codebook. The codebook can include components considering multiple AGs, and frequency/delay-domain channel profile and time/Doppler-domain channel profile.

In one example, the antenna architecture of the MIMO system is structured. For example, the antenna structure at each AG is dual-polarized (single or multi-panel as shown in FIG. 11. The antenna structure at each AG can be the same. Or, the antenna structure at an AG can be different from another AG. Likewise, the number of ports at each AG can be the same. Or, the number of ports at one AG can be different from another AG.

In another example, the antenna architecture of the MIMO system is unstructured. For example, the antenna structure at one AG can be different from another AG.

We assume a structured antenna architecture in the rest of the disclosure. For simplicity, we assume each AG is equivalent to a panel (cf. FIG. 11), although, an AG can have multiple panels in practice. The disclosure however is not restrictive to a single panel assumption at each AG, and can easily be extended (covers) the case when an AG has multiple antenna panels.

In one embodiment, an AG constitutes (or corresponds to or is equivalent to) at least one of the following:
In one example, an AG corresponds to a TRP.
In one example, an AG corresponds to a CSI-RS resource. A UE is configured with K=N_{g}>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained earlier in this disclosure.
In one example, an AG corresponds to a CSI-RS resource group, where a group comprises one or multiple NZP CSI-RS resources. A UE is configured with K≥N_{g}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained earlier in this disclosure. In particular, the K CSI-RS resources can be partitioned into N_{g} resource groups. The information about the resource grouping can be provided together with the CSI-RS resource setting/configuration, or with the CSI reporting setting/configuration, or with the CSI-RS resource configuration.
In one example, an AG corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an AG. The information about the subsets of ports or grouping of ports can be provided together with the CSI-RS resource setting/configuration, or with the CSI reporting setting/configuration, or with the CSI-RS resource configuration.
In one example, an AG corresponds to one or more examples described herein depending on a configuration. For example, this configuration can be explicit via a parameter (e.g., an RRC parameter). Or, it can be implicit.
   In one example, when implicit, it could be based on the value of K. For example, when K>1 CSI-RS resources, an AG corresponds to one or more examples described herein, and when K=1 CSI-RS resource, an AG corresponds to one or more examples described herein.
   In another example, the configuration could be based on the configured codebook. For example, an AG corresponds to a CSI-RS resource or resource group when the codebook corresponds to a decoupled codebook (modular or separate codebook for each AG), and an AG corresponds to a subset (or a group) of CSI-RS ports when codebook corresponds to a coupled (joint or coherent) codebook (one joint codebook across AGs).

In one example, when an AG maps (or corresponds to) a CSI-RS resource or resource group, and a UE can select a subset of AGs (resources or resource groups) and report the CSI for the selected AGs (resources or resource groups), the selected AGs can be reported via an indicator. For example, the indicator can be a CRI or a PMI (component) or a new indicator.

In one example, when an AG maps (or corresponds to) a CSI-RS port group, and a UE can select a subset of AGs (port groups) and report the CSI for the selected AGs (port groups), the selected AGs can be reported via an indicator. For example, the indicator can be a CRI or a PMI (component) or a new indicator (e.g., a bitmap).

In one example, CSI-RS herein in this disclosure comprises at least one or a combination of the following: CSI-RS for tracking (TRS), CSI-RS for CSI, CSI-RS for BM, CSI-RS for mobility or NZP CSI-RS resource for IMR (interference measurement) or a new type/usage of CSI-RS, namely, CSI-RS for calibration.

In one embodiment, a UE is configured with a calibration mechanism, wherein the UE is configured to perform one or more UL RS transmission(s), and/or to perform one or more DL RS reception(s)/measurement(s), and/or to report calibration-related information (e.g., for calibration coefficient for each TRP).

This configuration can be performed via higher-layer (RRC) signaling.
In one example, this configuration corresponds to a CSI resource setting configured via a higher layer IE CSI-ResourceConfig.
In one example, this configuration corresponds to a CSI resource set configured via a higher layer IE NZP-CSIRSResourceSet.
In one example, this configuration corresponds to a NZP CSI resource configured via a higher layer IE NZP-CSIRSResource.
In one example, this configuration corresponds to a CSI report setting configured via a higher layer IE CSI-ReportConfig.

In one example, the DL RS(s) can be one of or multiple of CSI-RS for CSI reporting, CSI-RS for tracking (TRS), CSI-RS for beam reporting, DL DMRS, or SSB/PBCH or a new type/usage of CSI-RS, namely, CSI-RS for calibration. In one example, DL RS can be a dedicated or new DL RS (for calibration purpose).

In one example, the UL RS(s) can be one of or multiple of SRS with usage=CB, SRS with usage=non-CB, SRS with usage=beamManagement, SRS with usage=AntennaSwitching, or UL DMRS. In one example, UL RS can be a dedicated or new UL RS (for calibration purpose).

In one example, the DL RS(s) can be aperiodic (AP) only.

In one example, the DL RS(s) can be AP or semi-persistent (SP).

In one example, the DL RS(s) can be AP or periodic (P).

In one example, the DL RS(s) can be SP or P.

In one example, the DL RS(s) can be AP or SP or P.

In one example, the UL RS(s) can be aperiodic (AP) only.

In one example, the UL RS(s) can be AP or semi-persistent (SP).

In one example, the UL RS(s) can be AP or periodic (P).

In one example, the UL RS(s) can be SP or P.

In one example, the UL RS(s) can be AP or SP or P.

In one example, the reporting can only be AP. In this case, the reporting can be triggered via a DCI (e.g., a CSI request field in UL-DCI).

In one example, the reporting can either be AP or SP. For AP, the reporting can be triggered via a DCI (e.g., a CSI request field in UL-DCI), and for SP, it can be triggered via MAC CE or DCI.

In one example, the reporting can only be UE-initiated (or UE-triggered). In this case, the reporting can be triggered via UL MAC CE (e.g., MAC CE for PHR reporting) or via a pre-notification message sent by the UE, where this message can be sent via SR (scheduling request) or via UCI (a pre-configured PUCCH or a PUSCH).

The term ‘precoder’ in this disclosure can be replaced with a spatial information (or TCI state, or spatialRelationInfo) or source RS or spatial filter, beamformer, beamforming vectors/matrices, precoding vector/matrices, or any other functionally equivalent quantity, that can be used for DL/UL RS reception/transmission.

### Calibration

In one embodiment, a UE is configured with a measurement and a report (e.g., CSI or calibration report) including calibration-related information (CLI) to enable/facilitate calibration/synchronization across Nₜᵣₚ≥1 TRPs or AGs or CSI-RS resources. In one example, the measurement can be configured via higher layer IE CSI-ResourceConfig indicating S≥1 sets of NZP CSI-RS resources. In one example, the measurement can be configured via higher layer IE NZP-CSIRS-ResourceSet indicating a set of NZP CSI-RS resources. In one example, the measurement can be configured via higher layer IE MeasObj. In one example, the report can be configured via higher layer CSI-ReportConfig with reportType set to a new value, e.g., ‘calibration’ or ‘cjt-calibration’.

### Measurement

Let hr be the measurement associated with r-th TRP (or CSI-RS resource or DL RS), where r=1, . . . , N and

$$\\ H = [ \begin{matrix}{h}_{1} ( t - δ {t}_{1} , f - δ {f}_{1} ) \\ {h}_{2} ( t - δ {t}_{2} , f - δ {f}_{2} ) \\ ⋮ \\ {h}_{N} ( t - δ {t}_{N} , f - δ {f}_{N} )\end{matrix} ]$$

be the composite/aggregated channel at a T-F unit (t, f) and {(δtᵣ, δfᵣ)} be the offsets associated with TRPs.

As described in this disclosure, one of the N TRPs can be a reference, whose offset can be fixed, e.g., to zero. Without loss generality, we can assume that the reference TRP (resource) corresponds to (the 1^{st} TRP) r*=1 for which (δt₁, δf₁)=(0,0), i.e.,

$$\\ H = [ \begin{matrix}{h}_{1} ( t , f ) \\ {h}_{2} ( t - δ {t}_{2} , f - δ {f}_{2} ) \\ ⋮ \\ {h}_{N} ( t - δ {t}_{N} , f - δ {f}_{N} )\end{matrix} ] .$$

In one example, all possible values of (δtᵣ, δfᵣ), based on the measurement, can be considered/used to determine the report.

In one example, a low-pass or a window-based approach can be used for the report. In one example, the window corresponds to value of (δtᵣ, δfᵣ) that are around the reference. For instance, δtᵣ≤Wₜ and/or δfᵣ≤W_{f}, where (Wₜ, W_{f}) corresponds to the window length or max value of (δtᵣ, δfᵣ) that can be considered/used for the report, (Wₜ, W_{f}) can be fixed, or configured, or reported by the UE.

In one example, the unit of CLI reporting is one of the following:
In one example, for time offset, the unit can be based on the CP length, or the symbol duration, or the slot duration. For example, 2^{N}^{_{T}} values within a window/interval, [0, x], x=CP length, min measurement interval. In one example, x=4.69×10⁻⁶ sec or 4.69 μsec. In one example, x=2^{z}×4.69×10⁻⁶ sec or 4.69 μsec where z∈{0,1,2,3,4}.
In one example, for time offset, the unit can be based on a fractional factor (between 0 and 1) of a TD unit. For example, 2^{N}^{_{T}} values within a window/interval, [0, x], x=TD unit length.
In one example, For frequency error (in ppm), the unit can be based on the window/interval, [0, x] or [−x, x], x=freq. error value specified in 38.104 (from RAN4). For example, 2^{N}^{_{F}} values within a window/interval, [0, x] or [−x, x], x=FD unit length. In one example, x=0.05 ppm (parts per million).
In one example, for time offset, the unit can be based on the normalized CP length, or the symbol duration, or the slot duration. For example, 2^{N}^{_{T}} values within a window/interval, [0, 1], 1 corresponds to CP length, min measurement interval. In one example, the CP length x=4.69×10⁻⁶ sec or 4.69 μsec. In one example, the CP length x=2^{z}×4.69×10⁻⁶ sec or 4.69 μsec where z∈{0,1,2,3,4}.
In one example, for time offset, the unit can be based on a normalized fractional factor (between 0 and 1) of a TD unit. For example, 2^{N}^{_{T}} values within a window/interval, [0, 1], 1 corresponds to TD unit length.
In one example, for frequency error (in ppm), the unit can be based on the normalized window/interval, [0, 1] or [−1,1], 1 corresponds to freq. error value, e.g., specified in 38.104 (from RAN4). For example, 2^{N}^{_{F}} values within a window/interval, [0, 1] or [−1,1], x=FD unit length. In one example, x=0.05 ppm (parts per million).

### Content of the Report

In one example, the CLI corresponds to at least one indicator indicating a measurement RS. For instance, the indicator can be CRI or SSBRI or other DL RS indicator when the measurement RS is NZP CSI-RS or SSB/PBCH block, or another DL RS. The at least one indicator can provide an implicit information about the offsets.

In one example, the CLI corresponds to the set of values of N or N−1 pairs {(δtᵣ, δfᵣ)} or indicator(s) indicating (quantized) values of {(δtᵣ, δfᵣ)}. At least one of the following examples of the codebook is used for quantizing {(δtᵣ, δfᵣ)}.
In one example, the codebook corresponds to a uniform quantizer Qᵤₙᵢ in linear scale.
   In one example, Qᵤₙᵢ includes 2^{B} values, uniformly/equally spaced/separated in [0, v], where B is the number of bits for quantization and v is the max value. In one example, the 2^{B} values include 0 and/or v.
      In one example, for time, v=sT_{CP} where T_{CP} is the CP length, and s is a scaling. In one example, s=1.
      In one example, for time, v=sTₛₗₒₜ where Tₛₗₒₜ is the slot duration, and s is a scaling. In one example, s=1.
      In one example, for frequency, v=sFₘᵢₙ where Fₘᵢₙ is the min requirement on the frequency error, e.g., in parts per million (ppm).
   In one example, Qᵤₙᵢ includes 2^{B} values, uniformly/equally spaced/separated in [u, v] where B is the number of bits for quantization, u is the min value, and v is the max value. In one example, the 2^{B} values include u and/or v.
   In one example, Qᵤₙᵢ includes 2^{B} values, uniformly/equally spaced/separated in [−v/2, v/2].
In one example, the codebook corresponds to a uniform quantizer Qᵤₙᵢ in logarithmic scale.
In one example, the codebook corresponds to a non-uniform (e.g., exponential) quantizer Qₙₒₙ₋ᵤₙᵢ.
   In one example, Qₙₒₙ₋ᵤₙᵢ includes Rel.15 3-bit amplitude codebook (Table 1).
   In one example, Qₙₒₙ₋ᵤₙᵢ includes Rel.16 3-bit or 4-bit amplitude codebook (Table 2, Table 3).
   In one example, Qₙₒₙ₋ᵤₙᵢ includes Rel.18 amplitude codebook for TDCP report (Table 4).

TABLE 1
Mapping of elements of k_{l, i}⁽¹⁾ to p_{l, i}⁽¹⁾

| k_{l, i}⁽¹⁾ | p_{l, i}⁽¹⁾ |
|---|---|
| 0 | 0 |
| 1 | \sqrt{1/64} |
| 2 | \sqrt{1/32} |
| 3 | \sqrt{1/16} |
| 4 | \sqrt{⅛} |
| 5 | \sqrt{¼} |
| 6 | \sqrt{½} |
| 7 | 1 |

TABLE 2
Mapping of elements of k_{l, p}⁽¹⁾ to p_{l, i}⁽¹⁾

| K_{l, p}⁽¹⁾ | P_{l, p}⁽¹⁾ |
|---|---|
| 0 | Reserved |
| 1 | $\frac{1}{\sqrt{128}}$ |
| 2 | ${( \frac{1}{8192} )}^{1 / 4}$ |
| 3 | $\frac{1}{8}$ |
| 4 | ${( \frac{1}{2048} )}^{1 / 4}$ |
| 5 | $\frac{1}{2 \sqrt{8}}$ |
| 6 | ${( \frac{1}{512} )}^{1 / 4}$ |
| 7 | $\frac{1}{4}$ |
| 8 | ${( \frac{1}{128} )}^{1 / 4}$ |
| 9 | $\frac{1}{\sqrt{8}}$ |
| 10 | ${( \frac{1}{32} )}^{1 / 4}$ |
| 11 | $\frac{1}{2}$ |
| 12 | ${( \frac{1}{8} )}^{1 / 4}$ |
| 13 | $\frac{1}{\sqrt{2}}$ |
| 14 | ${( \frac{1}{2} )}^{1 / 4}$ |
| 15 | 1 |

TABLE 3
Mapping of elements of k_{l, i}⁽¹⁾ to p_{l, i}⁽¹⁾

| k_{l, i, f}⁽²⁾ | p_{l, i, f}⁽²⁾ |
|---|---|
| 0 | $\frac{1}{8 \sqrt{2}}$ |
| 1 | $\frac{1}{8}$ |
| 2 | $\frac{1}{4 \sqrt{2}}$ |
| 3 | $\frac{1}{4}$ |
| 4 | $\frac{1}{2 \sqrt{2}}$ |
| 5 | $\frac{1}{2}$ |
| 6 | $\frac{1}{\sqrt{2}}$ |
| 7 | 1 |

TABLE 4
Mapping of elements kᵢ to aᵢ

| kᵢ | aᵢ |
|---|---|
| 0 | $\frac{1}{256}$ |
| 1 | $\frac{1}{128 \sqrt{2}}$ |
| 2 | $\frac{1}{128}$ |
| 3 | $\frac{1}{64 \sqrt{2}}$ |
| 4 | $\frac{1}{64}$ |
| 5 | $\frac{1}{32 \sqrt{2}}$ |
| 6 | $\frac{1}{32}$ |
| 7 | $\frac{1}{16 \sqrt{2}}$ |
| 8 | $\frac{1}{16}$ |
| 9 | $\frac{1}{8 \sqrt{2}}$ |
| 10 | $\frac{1}{8}$ |
| 11 | $\frac{1}{4 \sqrt{2}}$ |
| 12 | $\frac{1}{4}$ |
| 13 | $\frac{1}{2 \sqrt{2}}$ |
| 14 | $\frac{1}{2}$ |
| 15 | $\frac{1}{\sqrt{2}}$ |

In one example, for delay reporting, the codebook includes at least one value corresponding to a value larger than the CP length.
In one example, the codebook includes 2^{B} values in [0, x, x₁] where x₁>x and here x is the CP length, as described above.
In one example, the codebook includes 2^{B} values in [0,1, x₁] (normalized by the CP length) where x₁>1 and here 1 corresponds to the CP length, as described above.
In one example, the codebook includes 2^{B} values in [y, x, x₁] where 0<y, x₁>x and here x is the CP length, as described above.
In one example, the codebook includes 2^{B} values in [y, 1, x₁] (normalized by the CP length) where 0<y, x₁>1 and here 1 corresponds to the CP length, as described above.

In one example, for delay reporting, the codebook includes M≥1 values corresponding to values larger than the CP length.
In one example, the codebook includes 2^{B} values in [0, x, x₁, . . . , x_{M}] where xₘ>x, m=1, . . . , M, and here x is the CP length, as described above.
In one example, the codebook includes 2^{B} values in [0, 1, x₁, . . . , x_{M}] (normalized by the CP length) where xₘ>1, m=1, . . . , M, and here 1 corresponds to the CP length, as described above.
In one example, the codebook includes 2^{B} values in [y, x, x₁, . . . , x_{M}] where 0<y, xₘ>x, m=1, . . . , M and here x is the CP length, as described above.
In one example, the codebook includes 2^{B} values in [y, 1, x₁, . . . , x_{M}] (normalized by the CP length) where 0<y, xₘ>1, m=1, . . . , M and here 1 corresponds to the CP length, as described above.

In one example, for delay reporting, the codebook includes at least one code point P indicating that delay value is large than the CP length or corresponds to a value larger than the CP length.
In one example, the codebook includes 2^{B} values in [0, x, a] where x is the CP length, as described above. The code point P indicates a. In one example, a corresponds to NULL, Invalid, or a fixed value larger than x.
In one example, the codebook includes 2^{B} values in [0,1, a] (normalized by the CP length) where 1 corresponds to the CP length, as described above. The code point P indicates a. In one example, a corresponds to NULL, Invalid, or a fixed value larger than x.
In one example, the codebook includes 2^{B} values in [y, x, a] where 0<y, x is the CP length, as described above. The code point P indicates a. In one example, a corresponds to NULL, Invalid, or a fixed value larger than x.
In one example, the codebook includes 2^{B} values in [y, 1, a] (normalized by the CP length) where 0<y, 1 corresponds to the CP length, as described above. The code point P indicates a. In one example, a corresponds to NULL, Invalid, or a fixed value larger than x.

In one example, for delay reporting, the codebook includes at least one code point P indicating that delay value is large than the CP length or corresponds to a value larger than the CP length, and/or includes M≥1 values corresponding to values larger than the CP length.
In one example, the codebook includes 2^{B} values in [0, x, x₁, . . . , x_{M}, a] where x is the CP length and xₘ, as described above. The code point P indicates a. In one example, a corresponds to NULL, Invalid, or a fixed value larger than x.
In one example, the codebook includes 2^{B} values in [0, 1, x₁, . . . , x_{M}, a] (normalized by the CP length) where 1 corresponds to the CP length and xₘ, as described above. The code point P indicates a. In one example, a corresponds to NULL, Invalid, or a fixed value larger than x.
In one example, the codebook includes 2^{B} values in [y, x, x₁, . . . , x_{M}, a] where 0<y, x is the CP length and xₘ, as described above. The code point P indicates a. In one example, a corresponds to NULL, Invalid, or a fixed value larger than x.
In one example, the codebook includes 2^{B} values in [y, 1, x₁, . . . , x_{M}, a] (normalized by the CP length) where 0<y, 1 corresponds to the CP length and xₘ, as described above. The code point P indicates a. In one example, a corresponds to NULL, Invalid, or a fixed value larger than x.

In one example, M is fixed (e.g., 1). In one example, M is configured (e.g., RRC). In one example, M is reported by the UE.

In one example, x₁=x+δ, and δ is fixed (e.g., 1/t and t is an integer), is configured (e.g., RRC), is reported by the UE.

In one example, xₘ=x+δₘ, and δₘ is fixed (e.g.,

$$\\ \frac{1}{{t}_{m}}$$

and tₘ is an integer), is configured (e.g., RRC), is reported by the UE.

In one example, for frequency error reporting, the codebook includes at least one value corresponding to a value larger than the frequency error (x).
In one example, the codebook includes 2^{B} values in [0, x, x₁] or [−x₁, −x, x, x₁] where x₁>x and here x is the frequency error, as described above.
In one example, the codebook includes 2^{B} values in [0,1, x₁] or [−x₁, −1,1, x₁](normalized by the frequency error) where x₁>1 and here 1 corresponds to the frequency error, as described above.
In one example, the codebook includes 2^{B} values in [y, x, x₁] where 0<y, x₁>x and here x is the frequency error, as described above.
In one example, the codebook includes 2^{B} values in [y, 1, x₁] (normalized by the frequency error) where 0<y, x₁>1 and here 1 corresponds to the frequency error, as described above.

In one example, for frequency error reporting, the codebook includes M≥1 values corresponding to values larger than the frequency error.
In one example, the codebook includes 2^{B} values in [0, x, x₁, . . . , x_{M}] where xₘ>x, m=1, . . . , M, and here x is the CP length, as described above.
In one example, the codebook includes 2^{B} values in [0, 1, x₁, . . . , x_{M}] (normalized by the Frequency error) where xₘ>1, m=1, . . . , M, and here 1 corresponds to the Frequency error, as described above.
In one example, the codebook includes 2^{B} values in [y, x, x₁, . . . , x_{M}] where 0<y, xₘ>x, m=1, . . . , M and here x is the Frequency error, as described above.
In one example, the codebook includes 2^{B} values in [y, 1, x₁, . . . , x_{M}] (normalized by the Frequency error) where 0<y, xₘ>1, m=1, . . . , M and here 1 corresponds to the Frequency error, as described above.

In one example, for frequency error reporting, the codebook includes at least one code point P indicating that delay value is large than the Frequency error or corresponds to a value larger than the Frequency error.
In one example, the codebook includes 2^{B} values in [0, x, a] where x is the Frequency error, as described above. The code point P indicates a. In one example, a corresponds to NULL, Invalid, or a fixed value larger than x.
In one example, the codebook includes 2^{B} values in [0,1, a] (normalized by the Frequency error) where 1 corresponds to the Frequency error, as described above. The code point P indicates a. In one example, a corresponds to NULL, Invalid, or a fixed value larger than x.
In one example, the codebook includes 2^{B} values in [y, x, a] where 0<y, x is the Frequency error, as described above. The code point P indicates a. In one example, a corresponds to NULL, Invalid, or a fixed value larger than x.
In one example, the codebook includes 2^{B} values in [y, 1, a] (normalized by the Frequency error) where 0<y, 1 corresponds to the Frequency error, as described above. The code point P indicates a. In one example, a corresponds to NULL, Invalid, or a fixed value larger than x.

In one example, for frequency error reporting, the codebook includes at least one code point P indicating that delay value is large than the Frequency error or corresponds to a value larger than the Frequency error, and/or includes M≥1 values corresponding to values larger than the Frequency error.
In one example, the codebook includes 2^{B} values in [0, x, x₁, . . . , x_{M}, a] where x is the Frequency error and xₘ, as described above. The code point P indicates a. In one example, a corresponds to NULL, Invalid, or a fixed value larger than x.
In one example, the codebook includes 2^{B} values in [0, 1, x₁, . . . , x_{M}, a] (normalized by the Frequency error) where 1 corresponds to the Frequency error and xₘ, as described above. The code point P indicates a. In one example, a corresponds to NULL, Invalid, or a fixed value larger than x.
In one example, the codebook includes 2^{B} values in [y, x, x₁, . . . , x_{M}, a] where 0<y, x is the Frequency error and xₘ, as described above. The code point P indicates a. In one example, a corresponds to NULL, Invalid, or a fixed value larger than x.
In one example, the codebook includes 2^{B} values in [y, 1, x₁, . . . , x_{M}, a] (normalized by the Frequency error) where 0<y, 1 corresponds to the Frequency error and xₘ, as described above. The code point P indicates a. In one example, a corresponds to NULL, Invalid, or a fixed value larger than x.

In one example, M is fixed (e.g., 1). In one example, M is configured (e.g., RRC). In one example, M is reported by the UE.

In one example, x₁=x+δ, and δ is fixed (e.g.,

$$\\ \frac{1}{t}$$

and t is an integer), is configured (e.g., RRC), is reported by the UE.

In one example, xₘ=x+δₘ, and δₘ is fixed (e.g.,

$$\\ \frac{1}{{t}_{m}}$$

and tₘ is an integer), is configured (e.g., RRC), is reported by the UE.

In one example, the CLI corresponds to the set of values of N−1 phases {ϕᵣ} associated with (or due to) {(δtᵣ, δfᵣ)} or indicator(s) indicating (quantized) values of {ϕᵣ}. In one example, ϕᵣ=e^{j2π(f+δf}^{ᵣ}^{)(t+δt}^{ᵣ}⁾. At least one of the following examples of the codebook is used for quantizing {(δtᵣ, δfᵣ)}. In one example, the codebook corresponds 2^{e}=N_{PSK} bit codebook.
In one example, e=1. The 2 values corresponds to BPSK [1, −1].
In one example, e=2. The 4 values corresponds to QPSK [1, j, −1, −j].
In one example, e=3. The 8 values corresponds to 8PSK

$$\\ \{ {e}^{{}_{} j \frac{2 π k}{8}} : k = 0 , 1 , … , 7 \} .$$

In one example, e=4. The 16 values corresponds to 16PSK

$$\\ \{ {e}^{{}_{} j \frac{2 π k}{16}} : k = 0 , 1 , … , 15 \} .$$

In one example, e is configured via higher layer signaling, e.g., from {3,4}.

In one example, the UE also reports (indices indicating) the values of {(δtᵣ, δfᵣ)} associated with the reported {ϕᵣ}. In one example, the UE is configured with (indices indicating) the values of {(δtᵣ, δfᵣ)}.

In one example, the CLI can also include amplitude in addition to phase, i.e., cᵣ=aᵣϕᵣ.

At least one of the following examples is used/configured regarding the reporting/calculation.

In one example, the reporting is absolute, i.e., each of N values is determined/reported independently from other values.

In one example, the reporting is differential (relative) with respect to a base or reference. In one example, the based or reference is r=0, the 1^{st} TRP (resource). That is, the offset value corresponding to r>0 is reported/determined w.r.t. to the same corresponding to r=0. In one example, the reference can be fixed (e.g., 0), or configured (e.g., via higher layer) or reported by the UE (as part of the CSI report, either via part 1 or part 2 of a two-part UCI). In one example, the normalized value of the reference can also be reported by the UE.
In one example, the differential/relative offset value is determined as v′(r)=v(r)−v(0). The UE reports correlation v(0) for r=0, and c′(v) for v≠0.
In one example, the differential/relative offset is determined as

$$\\ {v}^{{}_{} ′} ( r ) = \frac{v ( r )}{v ( 0 )} .$$

The UE reports offset v(0) for r=0, and v′(r) for r≠0.
In one example, v=vₜ₋₁+\tilde{v}ₜ or v=vₜ₋₁×\tilde{v}ₜ.
In one example, vₜ=v₀+\tilde{v}ₜ or vₜ=v₀×\tilde{v}ₜ.

In one example, the report is a standalone/separate report (similar to Rel.18 time-domain channel property, TDCP), and doesn't include any other parameters. The report can be reported via a layer 1 (physical) UL channel such as PUCCH and/or PUSCH. In this case, the report can be multiplexed with other UCI parameters such as HARQ-ACK parameters. Alternatively, the report can be reported via a layer 2 (MAC) UL channel such as UL MAC CE. In this case, the report can be multiplexed with other MAC parameters such as PHR parameters.

In one example, the report is a non-standalone/joint report and can include other parameters such as CSI parameters (e.g., RI, CRI, PMI, CQI, and LI) and/or beam-related parameters (e.g., L1-RSRP, L1-SINR, CRI, SSBRI). In this case, the (calibration) report is a component (or part of) out of multiple components (or parts of) the CSI/beam report.

In one example, the CLI can be included as a component of (part of a codebook), e.g., Rel.18 Type II CJT codebook, and the corresponding configuration can be codebookMode=mode 3 (in addition to mode 1 and mode 2 in Rel.18).

In one example, a metric to obtain/derive/obtain the CLI is based on auto-(/cross-) correlation and/or power spectrum or power spectrum density of the measurement.

In one example, the measurement and reporting for T-F offset is decoupled/separate, i.e., one of the two separate mechanisms can be configured/used.
For time offset (δtᵣ), the measurement corresponds to multiple (a burst of) time occasions, where two consecutive time occasions can be separated by d symbols or slots.
For frequency offset (δfᵣ), the measurement corresponds to multiple (a burst of) frequency occasions, where two consecutive frequency occasions can be separated by d subcarriers or PRBs or SBs.

In one example, the measurement and reporting for T-F offset is coupled/joint, i.e., one joint mechanism is used/configured for a 2D measurement and reporting for (δtᵣ, δfᵣ).

At least one of the following examples is used/configured regarding the frequency domain granularity of the reporting/calculation of offset value(s).
In one example, the reporting/calculation of offset value(s) is in a wideband (WB) manner, i.e., offset values are reported common for the entire CSI reporting band.
In one example, the reporting/calculation of offset value(s) is in a subband (SB) manner, i.e., offset values are reported for each SB in the CSI reporting band. In addition, a reference (WB) offset can also be reported such that Sub-band offset level (s)=sub-band offset index (s)−wideband offset index.

Likewise, at least one of the following examples is used/configured regarding the time domain granularity of the reporting/calculation of offset value(s).
In one example, the reporting/calculation of offset value(s) is in a wide-time (WT) manner, i.e., offset values are reported common for the entire time window or duration (in which the report is expected to be valid).
In one example, the reporting/calculation of offset value(s) is in a sub-time (ST) manner, i.e., offset values are reported for each ST in the time duration (in which the report is expected to be valid). In addition, a reference (WT) offset can also be reported such that ST offset level (s)=ST offset index (s)−WT offset index.

In one example, the report includes one value for each TRP (N values when including the reference or N−1 values when excluding the reference). For time/delay offsets (Dr delay values d_{r,0}, . . . , d_{r,D}_{ᵣ}₋₁ sorted in increasing order)
In one example, the one value corresponds to the 1^{st} delay d_{r,0}.
In one example, the one value corresponds to the last delay d_{r,D}_{ᵣ}₋₁.
In one example, the one value corresponds to the max of {d_{r,i}_{ᵣ}}, iᵣ=0, . . . , Dᵣ−1.
In one example, the one value corresponds to the Delay spread DSᵣ=d_{r,D}_{ᵣ}₋₁−d_{r,0}.

Likewise, for frequency offsets (Fᵣ values f_{r,0}, . . . , f_{r,F}_{ᵣ}₋₁ sorted in increasing order)
In one example, the one value corresponds to the 1^{st} frequency f_{r,0}.
In one example, the one value corresponds to the last frequency f_{r,F}_{ᵣ}₋₁.
In one example, the one value corresponds to the max of {f_{r,i}_{ᵣ}}, i=0, . . . , Fᵣ−1.
In one example, the one value corresponds to the Frequency spread FSᵣ=f_{r,F}_{ᵣ}₋₁−f_{r,0}.

In one example, the report includes two values for each TRP. For time/delay offsets (Dᵣ delay values d_{r,0}, . . . , d_{r,D}_{ᵣ}₋₁ sorted in increasing order), “In one example, the two values can correspond to the 1^{st} and the last values d_{r,0} and d_{r,D}_{ᵣ}₋₁.
In one example, the two values can correspond to the max and the min of {d_{r,i}_{ᵣ}}, iᵣ=0, . . . , Dᵣ−1.
In one example, the two values can correspond to the two largest values of {d_{r,i}_{ᵣ}}, iᵣ=0, . . . , Dᵣ−1.

Likewise, for frequency offsets (Fᵣ values f_{r,0}, . . . , f_{r,F}_{ᵣ}₋₁ sorted in increasing order),
In one example, the two values can correspond to the 1^{st} and the last values f_{r,0} and f_{r,F}_{ᵣ}₋₁.
In one example, the two values can correspond to the max and the min of {f_{r,i}_{ᵣ}}, iᵣ=0, . . . , Fᵣ−1.
In one example, the two values can correspond to the two largest values of {f_{r,i}_{ᵣ}}, iᵣ=0, . . . , Fᵣ−1.

In one example, the report includes two values for each TRP.

In one example, the report includes two values for N−1 TRPs (excluding the reference TRP).

In one example, the report includes one value v_{ref} for the reference TRP, and two values for remaining TRPs, i.e., the two values for the reference are 0 and v_{ref}.

In one example, the report further includes a recommendation about coherency (CJT or NCJT) across TRPs. In one example, it can be implicit via one value, or explicit via an indicator (e.g., 1-bit), or via an Nₜᵣₚ-bit or N-bit bitmap indicator, where when the bitmap is all ‘0’ or all ‘1’ then it indicates NCJT and when at least two ‘1’s or ‘0’s then it indicates CJT.

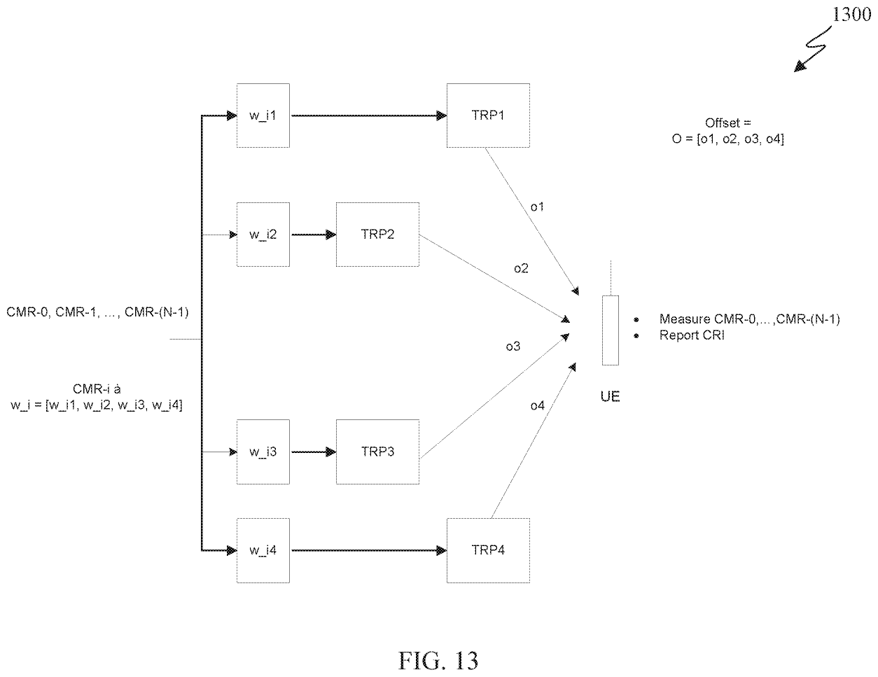

FIG. 13 an example 1300 of a UE configured with a CRI-based reporting scheme according to embodiments of the present disclosure. The embodiment of the example 1300 of a UE configured with a CRI-based reporting scheme illustrated in FIG. 13 is for illustration only. FIG. 13 does not limit the scope of this disclosure to any particular implementation of the example 1300 of a UE configured with a CRI-based reporting scheme.

In one embodiment, as illustrated in FIG. 13, a UE is configured with a measurement and a report (e.g., CSI report), as described above, based on a CSI reporting scheme.

Let oᵣ denote the actual offset for r-th TRP, where oᵣ=(Δtᵣ, Δfᵣ) or only Δtᵣ or only Δfᵣ.

For measurement, the UE is configured with Z≥1 channel measurement resources (CMRs) such as NZP CSI-RS resources, or SSBs, or other DL RSs. In one example, each CMR is a 1-port resource. In one example, Z=N. In one example, Z=Nₜᵣₚ. In one example, Z=aN or aNₜᵣₚ where a≥1. Each CMR-i can be associated with (or linked to) a candidate offset value o_{i,r}=(δt_{i,r}, δf_{i,r}) or calibration coefficient w_{i,r} for TRP r=1, . . . , N.

For reporting, the UE determines/reports n≥1 CRI(s) or other measurement RS indicator(s). This is akin to beam reporting in legacy NR specification. In one example n=1. In one example, the UE is configured with a value of n from a set {1, 2, . . . , Y}. In one example, a max value of Y=4, which can be subject to the UE capability reporting.

The report can also include an additional information.
In one example, the additional information includes a value of M, where M=0 corresponds to a NCJT hypothesis and M>0 corresponds to a CJT hypothesis.
In one example, the additional information includes a metric such as RSRP, SINR, or CQI or BLER or auto-/cross-correlation.

In one example, the UE is configured with S>1 sets of CMRs or S>1 groups of CMRs in one set, each set or group corresponds to (or associated with) a TRP. The report includes n≥1 groups of CRIs, each group comprising N CRIs.

Among the pros of this scheme is that there is no need for reporting of T-F offsets from UE-side. Among the cons of this scheme is the potentially large CMR overhead.

In one embodiment, each CMR can be further configured with a higher layer parameter repetition. When repetition is set to ON, the UE can perform Rx tuning.

In one embodiment, Z=1 and the CMR is configured with repetition, where the number of repetitions=the number of candidate offset values.

### Indication

In one example, the UE can also be indicated with some information about the candidate offset values o_{i,r}=(δt_{i,r}, δf_{i,r}) or calibration coefficients w_{i,r} or the corresponding measurement RS. This indication can be dynamic via DCI (DL-DCI or UL-DCI), or MAC CE, or RRC.

In one example, the UE is indicated with an indication about the offsets or calibration coefficients for CJT transmission.

In one example, this indication is based on the beam indication mechanism. In particular, a QCL-type or a new QCL-Info or a new TCI state definition can be introduced/specified to enable the calibration process.

The indication could also include an information about the coherence hypotheses, CJT and/or NCJT. For example, when v=0, NCJT; and v>0, CJT (may also include a value).

In one example, a new spec entity can be introduced for the calibration process.

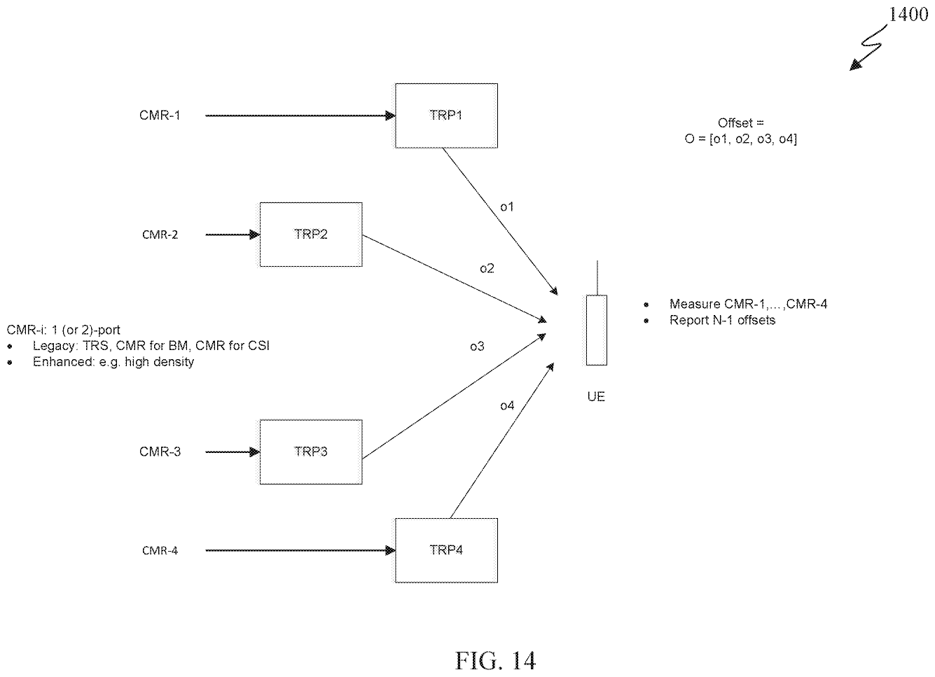

FIG. 14 illustrates an example 1400 of a UE configured with a CB-based reporting scheme according to embodiments of the present disclosure. The embodiment of the example 1400 of a UE configured with a CB-based reporting scheme illustrated in FIG. 14 is for illustration only. FIG. 14 does not limit the scope of this disclosure to any particular implementation of the example 1400 of a UE configured with a CRI-based reporting scheme.

In one embodiment, as illustrated in FIG. 14, a UE is configured with a measurement and a report (e.g., CSI report), as described above, based on a CB-based reporting scheme.

Let or denote the actual offset for r-th TRP, where oᵣ=(Δtᵣ, Δfᵣ) or only Δtᵣ or only Δfᵣ.

For measurement, the UE is configured with Z≥1 channel measurement resources (CMRs) such as NZP CSI-RS resources, or SSBs, or other DL RSs. In one example, each CMR is a 1-port resource. In one example, Z=N. In one example, Z=Nₜᵣₚ. In one example, Z=aN or aNₜᵣₚ where a≥1. Each CMR-i can be associated with (or linked to) a TRP r=1, . . . , N.

In one example, the TD granularity of the CMRs (i.e., time density) is s symbols, where s∈{1,2,4} (cf. PTRS). In one example, the FD granularity of the CMRs (i.e., frequency density) is t REs/RB, where t∈{1,3} (cf. TRS).

For reporting, the UE determines/reports.
In one example, w_{i,r}=(δt_{i,r}, δf_{i,r}) as described above.
In one example, (amp, phase) aᵣe^{jϕ}^{ᵣ}˜Aᵣe^{j2π(f+Δf)(t+Δt)} as described above.

The report can also include an additional information as described in the CRI-based scheme.

Among the pros of this scheme is that there is the reduction in number of CMRs or CMR overhead (when compared with the CRI-based scheme). Among the cons of this scheme is the increased reporting overhead.

In one embodiment,
For measurement:
   Each CMR is a 1 or 2 port resource, which can correspond to (N₁, N₂)=(1,1).
   Each CMR can be a≥4 port resource, which can correspond to (N₁, N₂) with N₁N₂≥2.
In one example, there can be a SD Basis, which can be fixed basis (no reporting), e.g., identity, or orthogonal DFT (with or without oversampling (O₁, O₂); or can be reported.
In one example, for frequency offset (FO), similar to FD, the granularity can be finer than SB, e.g., per PRB or per sub-PRB (comprising <12 subcarriers).
In one example, for time offset (TO), similar to Doppler domain (DD), the granularity can be, e.g., per slot, per x symbols (e.g., x=4 for TRS), 1, 2, 3, 4, 5 slots.

At least one of the examples is used/configured regarding the codebook for reporting.
In one example, the amplitude and/or phase codebooks corresponds to or is similar to or includes some of or all of the legacy (Rel.15, Rel.16 Type II, or Rel.18 TDCP).
In one example, the codebook is a vector codebook.
In one example, the codebook corresponds to an explicit feedback (e.g., based on PCA or Eigen basis).

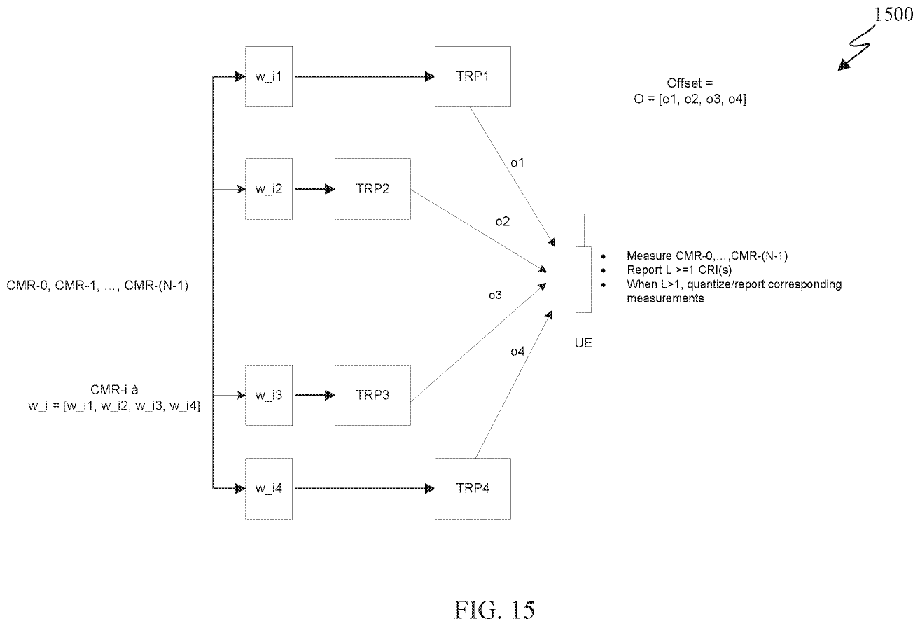

FIG. 15 illustrates an example 1500 of a UE configured with a CRI+CB-based reporting scheme according to embodiments of the present disclosure. The embodiment of the example 1500 of a UE configured with a CRI+CB-based reporting scheme illustrated in FIG. 15 is for illustration only. FIG. 15 does not limit the scope of this disclosure to any particular implementation of the example 1500 of a UE configured with a CRI+CB-based reporting scheme.

In one embodiment, as illustrated in FIG. 15, a UE is configured with a measurement and a report (e.g., CSI report), as described above, based on a CRI+CB-based reporting scheme, which is a combination of the CRI-based scheme and the CB-based scheme described above.

The details of the CMRs are the same as in the CRI-based scheme and/or the CB-based scheme.

The report corresponds to a two-level report, where Level 1 (based on the CRI-based scheme) includes L≥1 CRI(s), and Level 2 (based on the CB-based scheme) when L>1, includes L offsets for L selected/indicated CMRs.

Among the pros of this scheme is that Level 2 provides robustness (residual offset based on measurement), and the scheme balances the CMR vs reporting overhead trade-offs. Among the cons of this scheme is that it is more complex than the CRI-based scheme and the CB-based scheme.

In one embodiment, a UE is configured with a measurement and a report (e.g., CSI report) including calibration-related information (CLI) to enable/facilitate calibration/synchronization across Nₜᵣₚ≥1 TRPs or AGs or CSI-RS resources based on one of the CRI-based scheme, the CB-based scheme, or the CRI+CB-based scheme.
In one example, the UE is configured with one of the three scheme, e.g., via RRC, or MAC CE or DCI.
In one example, the configuration is subject to or based on the UE capability reporting for the support of one or more of the CRI-based scheme, the CB-based scheme, or the CRI+CB-based scheme.
In one example, the UE selects one of the three schemes, and reports the selection information.

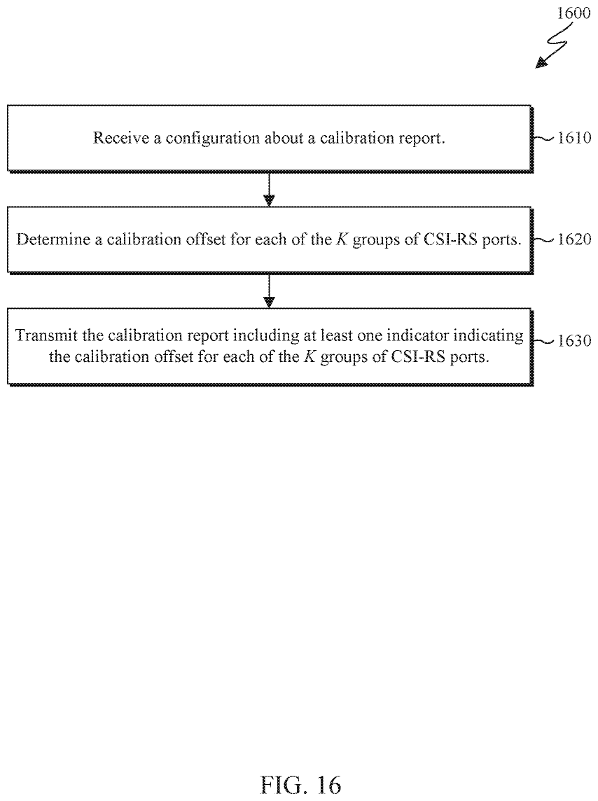

FIG. 16 illustrates an example method 1600 performed by a UE in a wireless communication system according to embodiments of the present disclosure. The method 1600 of FIG. 16 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1600 is for illustration only and other embodiments can be used without departing from the scope of the present disclosure.

The method 1600 begins with the UE receiving a configuration about a calibration report 1610. For example, in 1610, the configuration includes information about K groups of CSI-RS ports and a type of the calibration report.

The UE then determines a calibration offset for each of the K groups of CSI-RS ports 1620. For example, in 1620, the calibration offset is determined based on the configuration and the type of the calibration report is based on the calibration offset and corresponds to at least one of a DO, a FO, and a PO. In various embodiments, the type of the calibration report corresponds to one of the DO, the FO, the PO, and both the DO and FO.

In various embodiments, the calibration offset for a group r is relative to a reference group r*, where r∈{1, . . . , K} and r*∈{1, . . . , K}, the calibration offset for the reference group r* is fixed and not reported, and the calibration report includes an indicator indicating an index of the reference group r*.

In various embodiments, the calibration offset is based on a codebook that includes uniformly quantized intervals between 0 and A and a code point indicating an invalid state. For example, the codebook may be based on 2^{B} values [0, x₁, . . . , x_{M}, a], where xₘ=mδ with m=1, . . . , M and x_{M}=A, B and δ are values that are based on an radio resource control (RRC) configuration, A is based on: a cyclic prefix (CP) length when the type of calibration report corresponds to the DO, and a maximum frequency error (FE) when the type of calibration report corresponds to the FO, A=2π when the type of calibration report corresponds to the PO, and the value a is associated with the invalid state.

The UE then transmits the calibration report including at least one indicator indicating the calibration offset for each of the K groups of CSI-RS ports 1630. For example, in 1630, the calibration report relates to a CJT across the K groups of CSI-RS ports.

In various embodiments, when the type of the calibration report corresponds to DO, the calibration report further includes a 1-bit indicator associated with each group r, the 1-bit indicator indicating a hypothesis about the CJT across the K groups of CSI-RS ports.

In various embodiments, the K groups of CSI-RS ports are associated with K groups of NZP CSI-RS resources or resource sets, respectively, the information about the K groups of CSI-RS ports is via information about the K groups of NZP CSI-RS resources or resource sets, the calibration report is an aperiodic standalone report, and the calibration report is transmitted via a PUSCH. In some examples, the K groups of NZP CSI-RS resources or resource sets correspond to TRS resources or resource sets.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Any of the above variation embodiments can be utilized independently or in combination with at least one other variation embodiment.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver configured to receive a configuration about a calibration report, the configuration including information about (i) K groups of channel state information reference signal (CSI-RS) ports, where K>1, and (ii) a type of the calibration report; and
a processor operably coupled to the transceiver, the processor, based on the configuration, configured to determine a calibration offset for each of the K groups of CSI-RS ports,
wherein the transceiver is further configured to transmit the calibration report including at least one indicator indicating the calibration offset for each of the K groups of CSI-RS ports,
wherein the type of the calibration report (i) is based on the calibration offset and (ii) corresponds to at least one of a delay offset (DO), a frequency offset (FO), and a phase offset (PO), and
wherein the calibration report relates to a coherent joint transmission (CJT) across the K groups of CSI-RS ports.

2. The UE of claim 1, wherein:
the calibration offset for a group r is relative to a reference group r*, where r∈{1, . . . , K} and r*∈{1, . . . , K},
the calibration offset for the reference group r* is fixed and not reported, and
the calibration report includes an indicator indicating an index of the reference group r*.

3. The UE of claim 1, wherein the calibration offset is based on (i) a codebook that includes uniformly quantized intervals between 0 and A and (ii) a code point indicating an invalid state.

4. The UE of claim 3, wherein the codebook is based on 2^{B} values [0, x₁, . . . , x_{M}, a], where:
xₘ=mδ with m=1, . . . , M and x_{M}=A,
B and δ are values that are based on a radio resource control (RRC) configuration,
A is based on:
a cyclic prefix (CP) length when the type of calibration report corresponds to the DO, and
a maximum frequency error (FE) when the type of calibration report corresponds to the FO,
A=2π when the type of calibration report corresponds to the PO, and
the value a is associated with the invalid state.

5. The UE of claim 1, wherein, when the type of the calibration report corresponds to DO, the calibration report further includes a 1-bit indicator associated with each group r, the 1-bit indicator indicating a hypothesis about the CJT across the K groups of CSI-RS ports.

6. The UE of claim 1, wherein:
the K groups of CSI-RS ports are associated with K groups of NZP CSI-RS resources or resource sets, respectively,
the information about the K groups of CSI-RS ports is via information about the K groups of NZP CSI-RS resources or resource sets,
the calibration report is an aperiodic standalone report, and
the calibration report is transmitted via a physical uplink shared channel (PUSCH).

7. The UE of claim 6, wherein the K groups of NZP CSI-RS resources or resource sets correspond to CSI-RS for tracking (TRS) resources or resource sets.

8. The UE of claim 1, wherein the type of the calibration report corresponds to one of the DO, the FO, the PO, and both the DO and FO.

9. A base station (BS) comprising:
a processor; and
a transceiver operably coupled to the processor, the transceiver configured to:
transmit a configuration about a calibration report, the configuration including information about (i) K groups of channel state information reference signal (CSI-RS) ports, where K>1, and (ii) a type of the calibration report; and
receive the calibration report including at least one indicator indicating a calibration offset for each of the K groups of CSI-RS ports,
wherein the type of the calibration report (i) is based on the calibration offset and (ii) corresponds to at least one of a delay offset (DO), a frequency offset (FO), and a phase offset (PO), and
wherein the calibration report relates to a coherent joint transmission (CJT) across the K groups of CSI-RS ports.

10. The BS of claim 9, wherein:
the calibration offset for a group r is relative to a reference group r*, where r∈{1, . . . , K} and r*∈{1, . . . , K},
the calibration offset for the reference group r* is fixed and not reported, and
the calibration report includes an indicator indicating an index of the reference group r*.

11. The BS of claim 9, wherein the calibration offset is based on (i) a codebook that includes uniformly quantized intervals between 0 and A and (ii) a code point indicating an invalid state.

12. The BS of claim 11, wherein the codebook is based on 2^{B} values [0, x₁, . . . , x_{M}, a], where:
xₘ=mδ with m=1, . . . , M and x_{M}=A,
B and δ are values that are based on a radio resource control (RRC) configuration,
A is based on:
a cyclic prefix (CP) length when the type of calibration report corresponds to the DO, and
a maximum frequency error (FE) when the type of calibration report corresponds to the FO,
A=2π when the type of calibration report corresponds to the PO, and
the value a is associated with the invalid state.

13. The BS of claim 9, wherein, when the type of the calibration report corresponds to DO, the calibration report further includes a 1-bit indicator associated with each group r, the 1-bit indicator indicating a hypothesis about the CJT across the K groups of CSI-RS ports.

14. The BS of claim 9, wherein:
the K groups of CSI-RS ports are associated with K groups of NZP CSI-RS resources or resource sets, respectively,
the information about the K groups of CSI-RS ports is via information about the K groups of NZP CSI-RS resources or resource sets,
the calibration report is an aperiodic standalone report, and
the calibration report is transmitted via a physical uplink shared channel (PUSCH).

15. The BS of claim 14, wherein the K groups of NZP CSI-RS resources or resource sets correspond to CSI-RS for tracking (TRS) resources or resource sets.

16. The BS of claim 9, wherein the type of the calibration report corresponds to one of the DO, the FO, the PO, and both the DO and FO.

17. A method performed by a user equipment (UE), the method comprising:
receiving a configuration about a calibration report, the configuration including information about (i) K groups of channel state information reference signal (CSI-RS) ports, where K>1, and (ii) a type of the calibration report;
based on the configuration, determining a calibration offset for each of the K groups of CSI-RS ports; and
transmitting the calibration report including at least one indicator indicating the calibration offset for each of the K groups of CSI-RS ports,
wherein the type of the calibration report (i) is based on the calibration offset and (ii) corresponds to at least one of a delay offset (DO), a frequency offset (FO), and a phase offset (PO), and
wherein the calibration report relates to a coherent joint transmission (CJT) across the K groups of CSI-RS ports.

18. The method of claim 17, wherein:
the calibration offset for a group r is relative to a reference group r*, where r∈{1, . . . , K} and r*∈{1, . . . , K},
the calibration offset for the reference group r* is fixed and not reported, and
the calibration report includes an indicator indicating an index of the reference group r*.

19. The method of claim 17, wherein the calibration offset is based on (i) a codebook that includes uniformly quantized intervals between 0 and A and (ii) a code point indicating an invalid state.

20. The method of claim 19, wherein the codebook is based on 2^{B} values [0, x₁, . . . , x_{M}, a], where:
xₘ=mδ with m=1, . . . , M and x_{M}=A,
B and δ are values that are based on a radio resource control (RRC) configuration,
A is based on:
a cyclic prefix (CP) length when the type of calibration report corresponds to the DO, and
a maximum frequency error (FE) when the type of calibration report corresponds to the FO,
A=2π when the type of calibration report corresponds to the PO, and
the value a is associated with the invalid state.
